(19) United States
(12) Patent Application Publication
(10) Pub. No.: US 2023/0178765 A1
(43) Pub. Date: Jun. 8, 2023

(54) FUEL CELL STACK HUMIDIFICATION SYSTEM

(71) Applicants: CUMMINS INC., Columbus, IN (US); HYDROGENICS CORPORATION, Mississauga (CA)

(72) Inventors: Udit N. SHRIVASTAVA, East York (CA); Salvatore RANIERI, Etobicoke (CA); Paolo FORTE, Maple (CA); Justin Roberto RIZZI, Oshawa (CA); Archit N. KOTI, Sunnyvale, CA (US)

(21) Appl. No.: 18/057,534

(22) Filed: Nov. 21, 2022

Related U.S. Application Data
(60) Provisional application No. 63/286,395, filed on Dec. 6, 2021.
(60) Provisional application No. 63/295,719, filed on Dec. 31, 2021.

(51) Int. Cl. H01M 8/04119; H01M 8/04291; F24F 6/12

(52) U.S. Cl. CPC H01M 8/04141; H01M 8/04291; H01M 8/04156; F24F 6/12; H01M 2008/1095

(57) ABSTRACT

A humidification device includes a tubular mass exchanger fluidically coupled to receive intake air stream and transfer intake air stream to an intake air inlet of a fuel cell stack. The humidification device includes a housing configured to house the tubular mass exchanger to define a void therebetween. The housing defines at least one housing inlet opening fluidically coupled to direct an exhaust air stream output by the fuel cells tack into the void. The housing defines at least one housing outlet opening fluidically coupled to direct the exhaust air stream away from within the housing. The tubular mass exchanger is configured to extract water vapor from the exhaust air stream and transfer the extracted water vapor to the intake air stream flowing within the tubular mass exchanger to humidify the intake air stream to generate a humidified intake air stream.

### CROSS-REFERENCE TO RELATED APPLICATIONS

This nonprovisional application claims the benefit and priority, under 35 U.S.C. § 119(e) and any other applicable laws or statutes, to U.S. Provisional Patent Application Ser. No. 63/286,395 filed on Dec. 6, 2021 and U.S. Provisional Patent Application Ser. No. 63/295,719 filed on Dec. 31, 2021 the entire disclosures of which are hereby expressly incorporated herein by reference.

### TECHNICAL FIELD

The present disclosure generally relates to systems and methods for humidifying a fuel cell stack.

### BACKGROUND

A proton exchange membrane (PEM) fuel cell or fuel cell engine includes several subsystems that support converting chemical-potential energy into electrical-potential energy. For example, a fuel cell stack includes several cell assemblies electrically connected in series, compressed and bound to provide a compact power source. Other examples of subsystems that support the electrochemical reaction the fuel cell include, but are not limited to, a fuel handling system, an air handling system, and a coolant system. In mobility applications, a total package that is compact and reasonably light-weight is desirable to help facilitate vehicle integration, while in industrial or stationary applications the subsystems may be larger and/or integrated into facility bulk systems.

An air handling system in fuel cell system applications may provide an oxidant, e.g., oxygen, to the fuel cell reaction site. In mobility applications the atmospheric air is the most convenient way to deliver the oxygen as this eliminates the need for a tank supply system. Energy is then required to transport the air to the fuel cell reaction site. Robust and powerful performance of any PEM fuel cell is highly dependent on balancing membrane assembly humidification level.

### SUMMARY

Embodiments of the present invention are included to meet these and other needs.

In one aspect, described herein, a humidification system comprises a heat exchanger, a water trapping device, and an injector. The heat exchanger is fluidically coupled to a cathode outlet of a fuel cell stack to receive exhaust air stream therefrom and to cool the received exhaust air stream. The water trapping device is fluidically coupled to the heat exchanger and is configured to trap water droplets extracted from the exhaust air stream by the heat exchanger to generate a dry exhaust air stream. The injector is fluidically coupled to the water trapping device and is configured to receive at least a portion of the water droplets trapped by the water trapping device. The injector is also fluidically coupled upstream from a cathode inlet of the fuel cell stack and is configured to humidify a stream of air using the received portion of the water droplets prior to the stream of air entering the cathode inlet.

In some embodiments, the system may further comprise a turbine fluidically coupled to receive the dry exhaust air stream output by the water trapping device.

In some embodiments, the system may further comprise a fluid reservoir fluidically coupled between the water trapping device and the injector. The fluid reservoir may be configured to receive and store the water droplets from the water trapping device. The fluid reservoir may be configured to selectively provide at least the portion of the water droplets to the injector. In some embodiments, the system may further comprise a pump fluidically coupled between an outlet port of the fluid reservoir and a return port of the fluid reservoir. The pump may be configured to recirculate the water droplets output at the outlet port of the fluid reservoir toward the return port of the fluid reservoir. In some embodiments, the system may further comprise a valve coupled between an outlet of the pump and the return port of the fluid reservoir. The valve may be configured to operate in a first position to permit flow of water output by the pump toward the return port and in a second position to prevent the flow of water toward the return port. In some embodiments, the system may further comprise an injection branch fluidically coupled between the outlet of the pump and the valve. The injector may be coupled to the injection branch to receive at least the portion of the water droplets via the injection branch. In some embodiments, the injector may be configured to receive at least the portion of the water droplets by the injection branch in response to the valve being in the second positon.

In some embodiments, the system may further comprise a filter fluidically coupled between the water trapping device and the fluid reservoir. The filter may be configured to filter the water droplets output by the water trapping device.

According to another aspect, described herein, a method for humidifying a fuel cell of a fuel cell system includes the steps of receiving exhaust air stream from a cathode outlet of a fuel cell stack and cooling the received exhaust air stream, trapping water droplets extracted from the exhaust air stream to generate a dry exhaust air stream, and receiving at least a portion of the water droplets and humidifying a stream of air using the received portion of the water droplets prior to the stream of air entering a cathode inlet of the fuel cell stack.

In some embodiments, the method may further comprise the step of operating a turbine using the dry exhaust air stream. In some embodiments, the method may further comprise, prior to receiving at least the portion of the water droplets and humidifying the stream of air, the step of storing the water droplets. In some embodiments, the method may further comprise the step of recirculating the stored water droplets.

In another aspect, described herein, a fuel cell system comprises a fuel cell stack, a heat exchanger, a water trapping device, and an injector. The fuel cell stack has a cathode inlet and a cathode outlet. The fuel cell stack is configured to use the cathode inlet to receive intake air stream therethrough and use the cathode outlet to output exhaust airstream therethrough. The heat exchanger is fluidically coupled to the cathode outlet of the fuel cell stack to receive the exhaust air stream therefrom and to cool the received exhaust air stream. The water trapping device is fluidically coupled to the heat exchanger and is configured to trap water droplets extracted from the exhaust air stream by the heat exchanger by the heat exchanger to generate a dry exhaust air stream. The injector is fluidically coupled to the water trapping device and is configured to receive at least a portion of the water droplets trapped by the water trapping device. The injector is also fluidically coupled upstream from the cathode inlet of the fuel cell stack and is configured to humidify a stream of air using the received portion of the water droplets prior to the stream of air entering the cathode inlet.

In some embodiments, the system may further comprise a turbine fluidically coupled to receive the dry exhaust air stream output by the water trapping device.

In some embodiments, the system may further comprise a fluid reservoir fluidically coupled between the water trapping device and the injector. The fluid reservoir may be configured to receive and store the water droplets from the water trapping device. The fluid reservoir may be configured to selectively provide at least the portion of the water droplets to the injector.

In some embodiments, the system may further comprise a pump fluidically coupled between an outlet port of the fluid reservoir and a return port of the fluid reservoir. The pump may be configured to recirculate the water droplets output at the outlet port of the fluid reservoir toward the return port of the fluid reservoir. In some embodiments, the system may further comprise a valve coupled between an outlet of the pump and the return port of the fluid reservoir. The valve may be configured to operate in a first position to permit flow of water output by the pump toward the return port and in a second position to prevent the flow of water toward the return port.

In some embodiments, the system may further comprise an injection branch fluidically coupled between the outlet of the pump and the valve. The injector may be coupled to the injection branch to receive at least the portion of the water droplets via the injection branch. In some embodiments, the injector may be configured to receive at least the portion of the water droplets by the injection branch in response to the valve being in the second positon.

In some embodiments, the system may further comprise a filter fluidically coupled between the water trapping device and the fluid reservoir. The filter may be configured to filter the water droplets output by the water trapping device.

According to another aspect, described herein, a humidification device comprises a tubular mass exchanger and a housing. The tubular mass exchanger is fluidically coupled to receive intake air stream and transfer intake air stream to an intake air inlet of a fuel cell stack. The housing is configured to house the tubular mass exchanger to define a void therebetween.

The housing defines at least one housing inlet opening fluidically coupled to direct an exhaust air stream output by the fuel cell stack into the void. The housing also defines at least one housing outlet opening fluidically coupled to direct the exhaust air stream away from within the housing. The tubular mass exchanger is configured to extract water vapor from the exhaust air stream and transfer the extracted water vapor to the intake air stream flowing from within the tubular mass exchanger to humidify the intake air stream to generate a humidified intake air stream.

In some embodiments, an amount of water vapor extracted from the exhaust air stream and transferred to the intake air stream flowing within the tubular mass exchanger may be based on a difference in a first relative humidity of the exhaust air stream and a second relative humidity of the intake air stream. In some embodiments, an amount of water vapor extracted from the exhaust air stream may correspond to a portion of a surface area of the tubular mass exchanger interacting with the exhaust air stream prior to exhaust air stream exiting the void.

In some embodiments, the at least one housing outlet opening may be a first housing outlet opening. The exhaust air stream may interact with a first portion of the surface area of the tubular mass exchanger prior to exiting the void through the first housing outlet opening. The housing may define a second housing outlet opening.

The exhaust air stream may interact with a second portion of the surface area of the tubular mass exchanger prior to exiting the void through the housing outlet opening. In some embodiments, the second portion may be greater than the first portion. In some embodiments, the tubular mass exchanger may extract a first amount of water vapor from the exhaust air stream prior to the exhaust air stream exiting the void through the first housing outlet opening. The tubular mass exchanger may also extract a second amount of water vapor from the exhaust air stream prior to the exhaust air stream exiting the void through the second housing outlet opening. The second amount may be greater than the first amount. In some embodiments, the at least one housing inlet opening may be disposed immediately upstream from the intake air inlet of the fuel cell stack, the first housing outlet opening may be disposed upstream from the at least one housing inlet opening, and the second housing outlet opening may be disposed upstream from the first housing outlet opening.

In some embodiments, a material of the housing may include metal. In some embodiments, a material of the tubular mass exchanger may include one of a polymer and a resin. In some embodiments, the housing may include a bypass conduit configured to direct the exhaust air stream away from the at least one housing inlet opening to prevent the exhaust air stream from entering the void.

In another aspect of the present invention, described herein, a humidification system of a fuel cell system comprises a humidification device, a plurality of valves, and a controller. The humidification device includes a housing and a tubular mass exchanger disposed within the housing. The humidification device is coupled to an inlet port of a fuel cell stack to humidify an intake air stream transferred through the tubular mass exchanger prior to entering the inlet port. The plurality of valves is fluidically coupled to the housing to control flow of an exhaust air stream output by the fuel cell stack through the housing. The controller is communicatively coupled to command each of the plurality of valves to open and close. The controller is configured to, in response to humidity of the intake air stream at the intake air inlet being less than a predefined threshold, operate at least one of the plurality of valves to close to humidify the intake air stream using the water vapor extracted from the exhaust air stream to generate a humidified intake air stream.

In some embodiments, the system may further comprise a bypass conduit configured to direct the exhaust air stream to bypass the humidification device to bypass humidifying the intake air stream using the water vapor separated from the exhaust air stream. The at least one valve may be fluidically coupled to the bypass conduit. The controller may be configured to command the at least one valve to open to direct the exhaust air stream to bypass the humidification device. In some embodiments, the housing may define at least one opening configured to evacuate the exhaust air stream from the interior of the housing. In some embodiments, the humidification device may be configured to receive the intake air stream from a heat exchanger coupled upstream from the humidification device.

In some embodiments, the at least one of the plurality of valves may be a first valve. A second valve of the plurality of valves may be fluidically coupled to the housing to control removing the exhaust air stream from the interior of the housing. The controller may be configured to, in response to humidity of the intake air stream at the intake air inlet being less than a predefined threshold, command to open the second valve to remove the exhaust air stream.

In some embodiments, an amount of water vapor transferred by the tubular mass exchanger from the exhaust air stream to the intake air stream may be based on a difference between a first relative humidity of the exhaust air stream and a second relative humidity of the intake air stream. In some embodiments, a third valve of the plurality of valves may be disposed upstream from the second valve and may be configured to remove the exhaust air stream from the interior of the housing. The controller may be configured to operate the third valve to open in response to humidity of the intake air inlet being less than a second threshold.

A first amount of water vapor extracted by the tubular mass exchanger from the exhaust air stream in response to opening the second valve may be less than a second amount of water vapor extracted by the tubular mass exchanger from the exhaust air stream in response to opening the third valve. In some embodiments, the controller may be configured to command to close the first valve and the second valve in response to the humidity of the intake air stream at the intake air inlet being less than the second threshold.

In some embodiments, a material of the housing may include metal. A material of the tubular mass exchanger may include one of a polymer and resin. In some embodiments, the system may further comprise a sensor disposed within the intake air inlet and may be configured to detect humidity and temperature of the intake air stream directed into the intake air inlet. The controller may be communicatively coupled to receive signals from the sensor. The controller may command the at least one of the plurality of valves to open and to close based on the signals from the sensor.

### BRIEF DESCRIPTION OF THE DRAWINGS

The detailed description particularly refers to the following figures, in which:

FIG. 1A is a schematic view of an exemplary fuel cell system including an air delivery system, an electrolyzer, and a fuel cell module including a stack of multiple fuel cells;

FIG. 1B is a cutaway view of an exemplary fuel cell system including an air delivery system, an electrolyzer, and a plurality of fuel cell stacks;

FIG. 1C is a perspective view of an exemplary repeating unit of a fuel cell stack of the fuel cell system of FIG. 1A;

FIG. 1D is a cross-sectional view of an exemplary repeating unit of the fuel cell stack of FIG. 1C;

FIG. 2 is a block diagram illustrating an example fuel cell system including the fuel cell of FIG. 1C;

FIGS. 3A and 3B are block diagrams illustrating an example implementation of a membrane-based humidification system for a fuel cell stack including at least one fuel cell of FIG. 1C;

FIG. 4 is a block diagram illustrating an example humidification system for the fuel cell stack including at least one fuel cell of FIG. 1C;

FIGS. 5A and 5B are block diagrams illustrating another implementation of the humidification system of FIG. 4;

FIG. 6 is a block diagram illustrating still another implementation of the humidification of system of FIG. 4;

FIG. 7 is a block diagram illustrating an air handling system including the humidification system of FIG. 4;

FIGS. 8A and 8B are block diagrams illustrating example implementations of a humidification system in accordance with the present disclosure;

FIG. 9 is a flowchart illustrating an example process for humidifying the fuel cell of FIG. 1C using the humidification system of FIG. 8A; and

FIG. 10 is a flowchart illustrating another example process for humidifying the fuel cell of FIG. 1C using the humidification systems of FIGS. 8A and 8B;

FIG. 11 is a block diagram illustrating a top view of an example implementation of a housing and a tubular mass exchanger of the humidification systems of FIGS. 8A and 8B; and

FIG. 12 is a block diagram illustrating a detailed view of a portion of the humidification system of FIG. 8A.

### DETAILED DESCRIPTION

Air displacement must be induced within a core of a fuel cell 20, such as by a positive displacement device, e.g., a supercharger, or a centrifugal device, a compressor stage of a turbocharger. These devices may be powered by an electric motor that receives a supply of current from a fuel cell stack 12. Put another way, design of a given air handling system 600, 700 of the fuel cell system 10 may require a supply of power, thereby causing the net output of the fuel cell system 10 to be reduced.

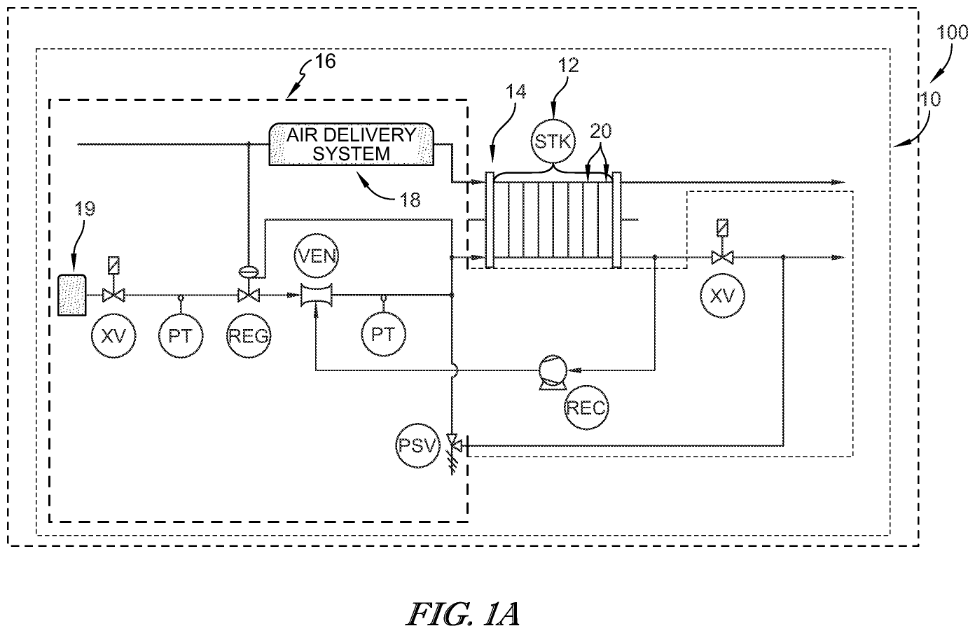

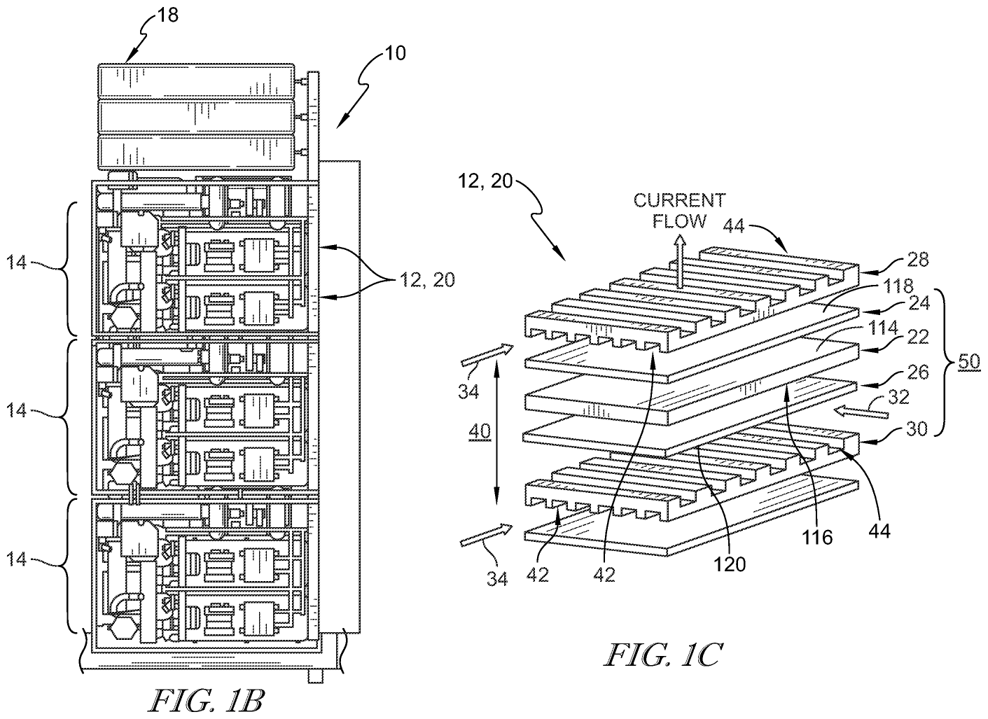

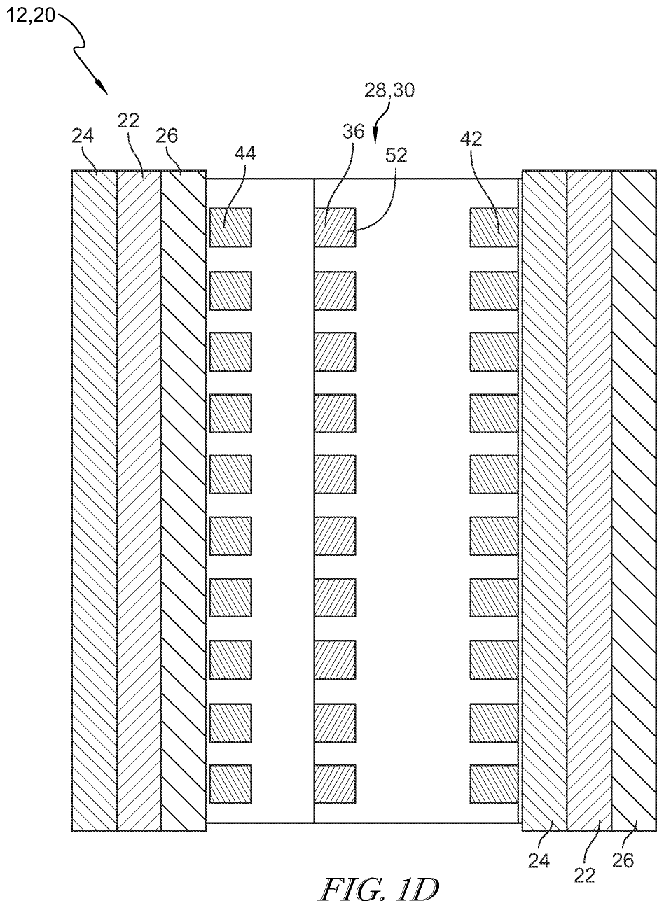

As shown in FIG. 1A, fuel cell systems 10 often include one or more fuel cell stacks 12 or fuel cell modules 14 connected to a balance of plant (BOP) 16, including various components, to support the electrochemical conversion, generation, and/or distribution of electrical power to help meet modern day industrial and commercial needs in an environmentally friendly way. As shown in FIGS. 1B and 1C, fuel cell systems 10 may include fuel cell stacks 12 comprising a plurality of individual fuel cells 20. Each fuel cell stack 12 may house a plurality of fuel cells 20 assembled together in series and/or in parallel. The fuel cell system 10 may include one or more fuel cell modules 14 as shown in FIGS. 1A and 1B.

Each fuel cell module 14 may include a plurality of fuel cell stacks 12 and/or a plurality of fuel cells 20. The fuel cell module 14 may also include a suitable combination of associated structural elements, mechanical systems, hardware, firmware, and/or software that is employed to support the function and operation of the fuel cell module 14. Such items include, without limitation, piping, sensors, regulators, current collectors, seals and insulators.

The fuel cells 20 in the fuel cell stacks 12 may be stacked together to multiply and increase the voltage output of a single fuel cell stack 12. The number of fuel cell stacks 12 in a fuel cell system 10 can vary depending on the amount of power required to operate the fuel cell system 10 and meet the power need of any load. The number of fuel cells 20 in a fuel cell stack 12 can vary depending on the amount of power required to operate the fuel cell system 10 including the fuel cell stacks 12.

The number of fuel cells 20 in each fuel cell stack 12 or fuel cell system 10 can be any number. For example, the number of fuel cells 20 in each fuel cell stack 12 may range from about 100 fuel cells to about 1000 fuel cells, including any specific number or range of number of fuel cells 20 comprised therein (e.g., about 200 to about 800). In an embodiment, the fuel cell system 10 may include about 20 to about 1000 fuel cells stacks 12, including any specific number or range of number of fuel cell stacks 12 comprised therein (e.g., about 200 to about 800). The fuel cells 20 in the fuel cell stacks 12 within the fuel cell module 14 may be oriented in any direction to optimize the operational efficiency and functionality of the fuel cell system 10.

The fuel cells 20 in the fuel cell stacks 12 may be any type of fuel cell 20. The fuel cell 20 may be a polymer electrolyte membrane or proton exchange membrane (PEM) fuel cell, an anion exchange membrane fuel cell (AEMFC), an alkaline fuel cell (AFC), a molten carbonate fuel cell (MCFC), a direct methanol fuel cell (DMFC), a regenerative fuel cell (RFC), a phosphoric acid fuel cell (PAFC), or a solid oxide fuel cell (SOFC). In an exemplary embodiment, the fuel cells 20 may be a polymer electrolyte membrane or proton exchange membrane (PEM) fuel cell or a solid oxide fuel cell (SOFC).

In an embodiment shown in FIG. 1C, the fuel cell stack 12 includes a plurality of proton exchange membrane (PEM) fuel cells 20. Each fuel cell 20 includes a single membrane electrode assembly (MEA) 22 and a gas diffusion layers (GDL) 24, 26 on either or both sides of the membrane electrode assembly (MEA) 22 (see FIG. 1C). The fuel cell 20 further includes a bipolar plate (BPP) 28, 30 on the external side of each gas diffusion layers (GDL) 24, 26, as shown in FIG. 1C. The above-mentioned components, in particular the bipolar plate 30, the gas diffusion layer (GDL) 26, the membrane electrode assembly (MEA) 22, and the gas diffusion layer (GDL) 24 comprise a single repeating unit 50.

The bipolar plates (BPP) 28, 30 are responsible for the transport of reactants, such as fuel 32 (e.g., hydrogen) or oxidant 34 (e.g., oxygen, air), and cooling fluid 36 (e.g., coolant and/or water) in a fuel cell 20. The bipolar plates (BPP) 28, 30 can uniformly distribute reactants 32, 34 to an active area 40 of each fuel cell 20 through oxidant flow fields 42 and/or fuel flow fields 44 formed on outer surfaces of the bipolar plates (BPP) 28, 30. The active area 40, where the electrochemical reactions occur to generate electrical power produced by the fuel cell 20, is centered, when viewing the stack 12 from a top-down perspective, within the membrane electrode assembly (MEA) 22, the gas diffusion layers (GDL) 24, 26, and the bipolar plate (BPP) 28, 30.

The bipolar plates (BPP) 28, 30 may each be formed to have reactant flow fields 42, 44 formed on opposing outer surfaces of the bipolar plate (BPP) 28, 30, and formed to have coolant flow fields 52 located within the bipolar plate (BPP) 28, 30, as shown in FIG. 1D. For example, the bipolar plate (BPP) 28, 30 can include fuel flow fields 44 for transfer of fuel 32 on one side of the plate 28, 30 for interaction with the gas diffusion layer (GDL) 26, and oxidant flow fields 42 for transfer of oxidant 34 on the second, opposite side of the plate 28, 30 for interaction with the gas diffusion layer (GDL) 24. As shown in FIG. 1D, the bipolar plates (BPP) 28, 30 can further include coolant flow fields 52 formed within the plate (BPP) 28, 30, generally centrally between the opposing outer surfaces of the plate (BPP) 28, 30. The coolant flow fields 52 facilitate the flow of cooling fluid 36 through the bipolar plate (BPP) 28, 30 in order to regulate the temperature of the plate (BPP) 28, 30 materials and the reactants. The bipolar plates (BPP) 28, 30 are compressed against adjacent gas diffusion layers (GDL) 24, 26 to isolate and/or seal one or more reactants 32, 34 within their respective pathways 44, 42 to maintain electrical conductivity, which is required for robust operation of the fuel cell 20 (see FIGS. 1C and 1D).

The fuel cell system 10 described herein, may be used in stationary and/or immovable power system, such as industrial applications and power generation plants. The fuel cell system 10 may also be implemented in conjunction with an air delivery system 18. Additionally, the fuel cell system 10 may also be implemented in conjunction with a source of hydrogen 19 such as a pressurized tank, including a gaseous pressurized tank, cryogenic liquid storage tank, chemical storage, physical storage, stationary storage, or electrolyzers. In one embodiment, the fuel cell system 10 is connected and/or attached in series or parallel to a source of hydrogen 19, such as one or more sources of hydrogen 19 in the BOP 16 (see FIG. 1A). In another embodiment, the fuel cell system 10 is not connected and/or attached in series or parallel to a source of hydrogen 19.

The present fuel cell system 10 may also be comprised in mobile applications. In an exemplary embodiment, the fuel cell system 10 is in a vehicle and/or a powertrain 100. A vehicle 100 comprising the present fuel cell system 10 may be an automobile, a pass car, a bus, a truck, a train, a locomotive, an aircraft, a light duty vehicle, a medium duty vehicle, or a heavy-duty vehicle. Type of vehicles 100 can also include, but are not limited to commercial vehicles and engines, trains, trolleys, trams, planes, buses, ships, boats, and other known vehicles, as well as other machinery and/or manufacturing devices, equipment, installations, among others.

The vehicle and/or a powertrain 100 may be used on roadways, highways, railways, airways, and/or waterways. The vehicle 100 may be used in applications including but not limited to off highway transit, bobtails, and/or mining equipment. For example, an exemplary embodiment of mining equipment vehicle 100 is a mining truck or a mine haul truck.

In addition, it may be appreciated by a person of ordinary skill in the art that the fuel cell system 10, fuel cell stack 12, and/or fuel cell 20 described in the present disclosure may be substituted for any electrochemical system, such as an electrolysis system (e.g., an electrolyzer), an electrolyzer stack, and/or an electrolyzer cell (EC), respectively. As such, in some embodiments, the features and aspects described and taught in the present disclosure regarding the fuel cell system 10, stack 12, or cell 20 also relate to an electrolyzer, an electrolyzer stack, and/or an electrolyzer cell (EC). In further embodiments, the features and aspects described or taught in the present disclosure do not relate, and are therefore distinguishable from, those of an electrolyzer, an electrolyzer stack, and/or an electrolyzer cell (EC).

FIG. 1C illustrates an example implementation of a fuel cell 20 in accordance with the present disclosure. The fuel cell 20 includes a plurality of layers, such as, but not limited to, a membrane electrode assembly layer 22, first and second gas diffusion layers 24, 26, and first and second bipolar plates 28, 30. The first gas diffusion layer 24, 26 may be disposed immediately adjacent a first side 114 of the membrane electrode assembly layer 22 and the second gas diffusion layer 26 may be disposed immediately adjacent a second side 116 of the membrane electrode assembly layer 22, where the first side 114 is disposed opposite the second side 116.

The first bipolar plate 28 may be disposed immediately adjacent a first side 118 of the first gas diffusion layer 24 and the second bipolar plate 30 may be disposed immediately adjacent a first side 120 of the second gas diffusion layer 26. In response to being exposed to fuel flow 32, e.g. hydrogen, the membrane electrode assembly layer 22 is configured to initiate, carry out, or undergo the electrochemical reaction to generate electric energy and any byproducts, such as exhaust gases, water, and so on. Effective management of an air handling system 600, 700 serving the membrane electrode assembly layer 22, and, ultimately, the entire fuel cell stack 12, is necessary to ensure efficient operation of the fuel cell 20.

The gas diffusion layers 24, 26 are diffusers configured to condition a flow of air or fuel through channels of the bipolar plates 28, 30, respectively, to permit the air 34 or fuel 32 to interface with surfaces of the membrane electrode assembly layer 22 to initiate an electrochemical reaction.

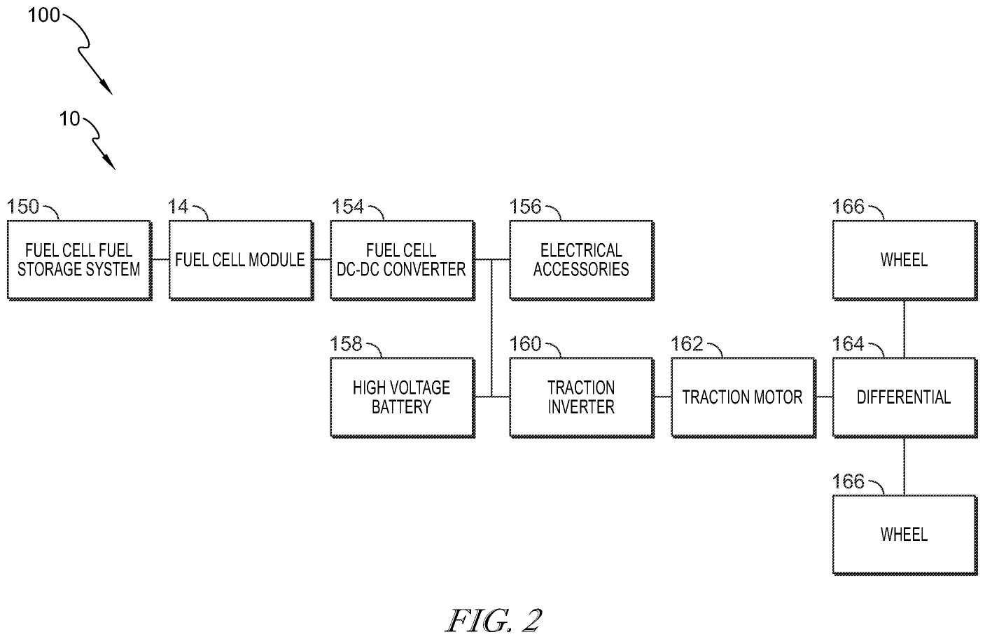

FIG. 2 illustrates an example implementation of a fuel cell system 10 in accordance with the present disclosure. While the fuel cell system 10 illustrated and described in reference to FIG. 2 is for vehicle 100 applications, the humidification systems 302, 402, 403, 502, 702, 703 and methods 800, 900 disclosed herein are not so limited. Example applications of the systems 302, 402, 403, 502, 702, 703 and methods 800, 900 for humidification of a fuel cell stack 12 in accordance with the present disclosure include, but are not limited to, stationary or semi-stationary applications in personal, residential, and/or industrial context. Example non-stationary applications of the humidification 302, 402, 403, 502, 702, 703 and methods 800, 900 of the present disclosure include vehicular and mobile applications, whether operator-controlled, autonomous, or semi-autonomous, such as, but are not limited to, automobiles, vans, trucks, agricultural machinery and equipment, trains, marine vehicles, aircraft, spacecraft, satellite, and drone. In an example, the fuel cell system 10 may be configured to include one or more fuel cells 20, such as the example fuel cell 20 described in reference to FIG. 1C.

The example fuel cell system 10 shown in FIG. 2 includes a fuel cell fuel storage system 150, a fuel cell module 14, a high voltage battery 158, and a traction motor 162. The fuel cell fuel storage system 150 of the example fuel cell system 10 provides fuel cell fuel 32 (e.g., hydrogen or compressed natural gas (CNG)) to the a fuel cell module 14. The fuel cell module 14 uses a chemical process to generate electrical energy. The electrical energy generated by the a fuel cell module 14 may be stored in the high voltage battery 158 for use by one or more propulsion or non-propulsion components of the example fuel cell system 10. Further, at least a portion of the electrical energy generated by the a fuel cell module 14, whether directly or via the high voltage battery 158, may be used to power the traction motor 162. The traction motor 162 is mechanically coupled to a differential 164 that distributes power to wheels 166 to operate the example fuel cell system 10. Still further, at least a portion of the electrical energy generated by the a fuel cell module 14, whether directly or via the high voltage battery 158, may be transferred to power electrical components 156 of the example fuel cell system 10, such as interior lighting, cabin cooling, and infotainment system.

A fuel cell DC-DC converter 154 steps up DC power output by the a fuel cell module 14 to a voltage compatible with the electrical accessories 156 and/or the high voltage battery 158. A traction inverter 160 inverts DC power supplied by the high voltage battery 158 and/or by the a fuel cell module 14 to AC power compatible with the traction motor 162. The traction inverter 160 may be bi-directional and may convert AC power output by the traction motor 162 operating in a generator mode to DC power for transfer to the high voltage battery 158.

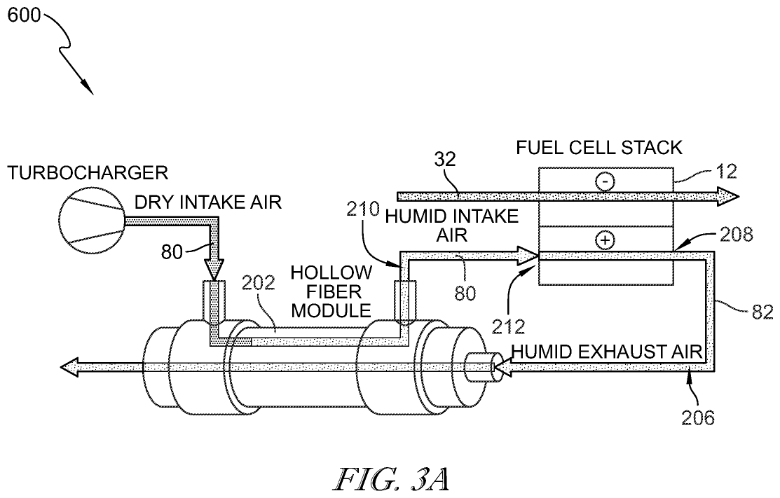

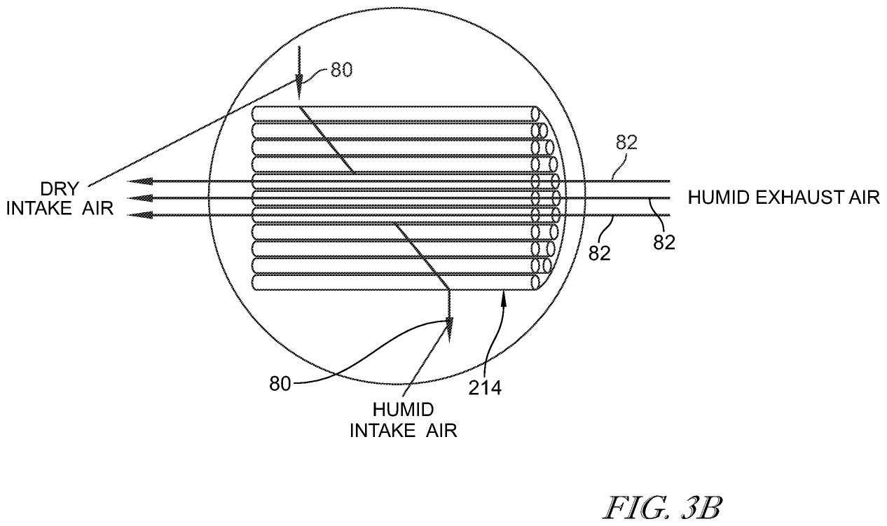

Humidifiers 202 may be configured to increase the power density of the fuel cell. FIG. 3A illustrates an example implementation of a humidification device 202 for a fuel cell stack 12. The fuel cell stack 12 may be said to be “humidified”, i.e., the fuel cell stack 12 includes the humidification device 202, or another water recirculation device, may remove humidity 206 exhausted at an outlet 208 of the fuel cell stack 12 and may recirculate a portion 210 of the removed moisture 206 back into an inlet 212 of the fuel cell stack 12. The humidification device 202 may operate in a manner similar to a heat exchanger having a water permeable membrane 214 (rather than sheet metal) that allows the wicking of water vapor 206 across the process streams while retaining the air spaces as shown in FIG. 3B.

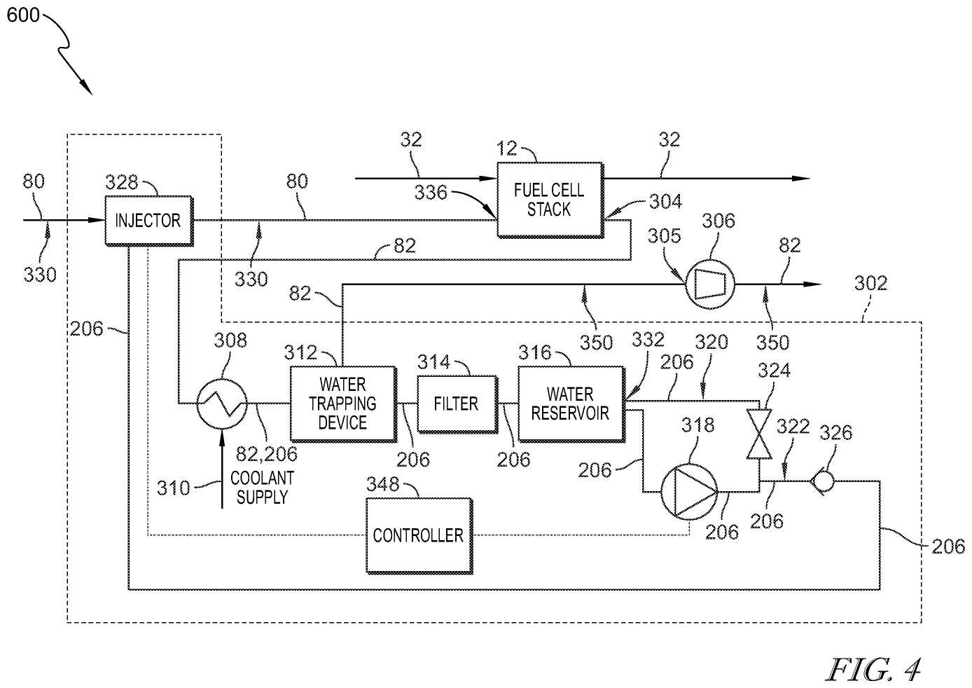

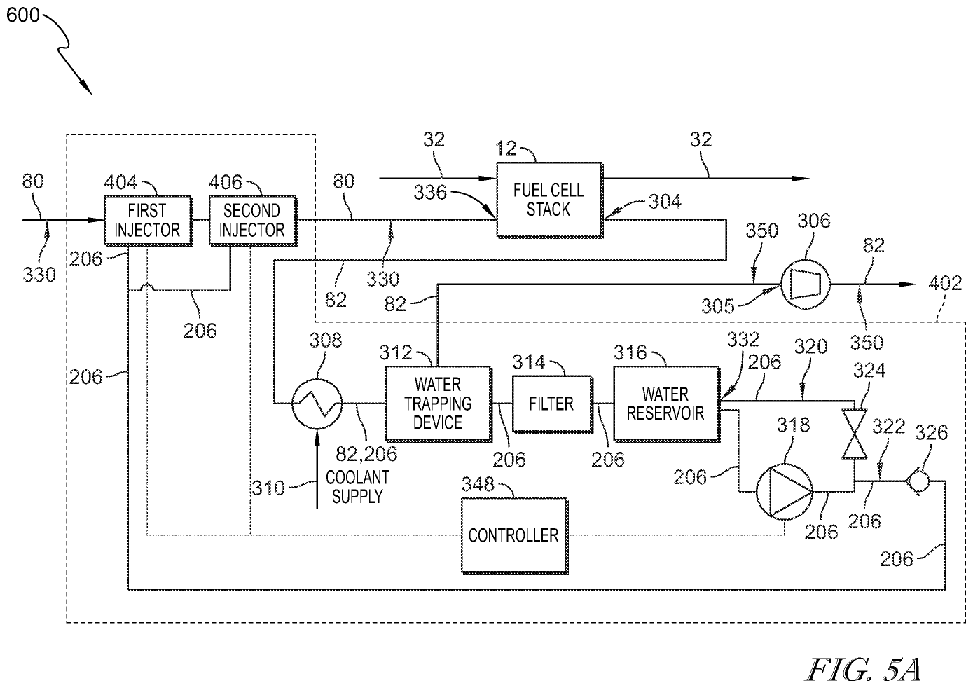

FIG. 4 illustrates an example humidification system 302 of the fuel cell stack 12. A humidification system 302 of the present disclosure is an active, direct-acting system that introduces water 206 into the intake air stream of the fuel cell stack 12 without use of humidifier membranes 214. The humidification system 302 effectively avoids icing and/or mold growth that may occur in traditional humidification systems.

As shown in FIG. 4, a humidification system 302 in accordance with the present disclosure couples to a cathode exhaust outlet 304 of the fuel cell stack 12. Typically, exhaust stream 82 leaving the fuel cells stack 12 is output directly to an exhaust air stream recirculation loop 82, including, among other components, a turbine 306. The turbine 306 is configured to recuperate energy from the exhaust stream 82 output by the fuel cell stack 12, and can be used as a direct connection to the compressor (not shown) to reduce the pumping requirements for the air handling system 600. When the turbine 306 is supplied with highly saturated cathode air 82, the expansion process may cause condensation. And if the exhaust stream 82 is at, or near, the point of full saturation, water droplets 206 are likely to form during the expansion process.

In an example, at least a portion of the humidification system 302 may be coupled between the cathode exhaust outlet 304 and an input 305 to the turbine 306. In other examples, the humidification system 302 may be coupled to one or more different components of the exhaust air stream recirculation loop 82 coupled either upstream or downstream from the turbine 306.

Still referring to FIG. 4, liquid water 206 formation within the turbine 306 may be prevented by changing the thermodynamic properties of the air 82 in accordance with the present disclosure. The humidification system 302 includes a heat exchanger 308 configured to cool the exhaust stream 82 using a coolant supply branch 310. Cooling the cathode exhaust stream generates water droplets 206 that may be harvested by, or may collect in, a water trapping device 312 fluidically coupled to the heat exchanger 308.

The exhaust air stream 82, having passed through the water trapping device 312, may be returned to the exhaust branch 350. Moisture content of the exhaust air 82 in the exhaust branch 350 is, thereby, reduced. The humidification system 302 of the present disclosure provides for using a reheater, such as the heat exchanger 308, to increase temperature of exhaust air stream 82 entering the turbine 306, such that the exhaust air 82 entering an input 305 of the turbine 306 is dryer than the exhaust air stream 82 that exited the cathode outlet 304 of the fuel cell stack 12.

Reducing relative humidity of the air stream 82 entering the turbine 306 may eliminate or slow corrosion processes within the turbine 306, thereby, increasing effectiveness and efficiency and prolonging operating life of the turbine 306. In some instances, where compressed air is used as a heat source to reheat exhaust air stream 82 before that exhaust air stream 82 enters the turbine 306, temperature of the exhaust air stream entering the turbine 306 may be greater than or equal to 180° C. In one example, the heat exchanger 308 is fluidically coupled between the compressor discharge and an inlet 305 of the turbine 306, swapping the compressed air heat with the cooler exhaust air 82. This enables a reduction in relative humidity, e.g., reduction in relative humidity by less than or equal to 80%.

After reducing relative humidity of the exhaust air 82, the molar ratio of the remaining constituents (now largely oxygen and nitrogen) are proportionally larger. For example, the specific heat values of pure water, nitrogen, and oxygen (1.866 kJ/kgK, 1.037 kJ/kgK, 0.914 kJ/kgK, respectively) may decrease with the lowering of the relative humidity of exhaust air stream 82, thus making the use of a reheater, such as the heat exchanger 308, more effective in ensuring a greater vaporization in the exhaust stream 82 entering the turbine 306. This results in longer life expectancy of the turbine 306 and reduces the requirements for erosion protection methods of the blades of the turbine 306.

With reference to FIG. 4, water 206 trapped by the water trapping device 312 may collect in a water reservoir 316 coupled downstream from the water trapping device 312. A filter 314 fluidically coupled between the water trapping device 312 and the water reservoir 316 filters water droplets 206 trapped by the water trapping device 312 before the droplets 206 enter the water reservoir 316.

A water pump 318 disposed downstream from and fluidically coupled to the water reservoir 316. The water pump 318 receives at least a portion of the liquid 206 from the water reservoir 316. In an example, the water pump 318 may circulate the received water 206 back into the water reservoir 316, e.g., via a recirculation branch 320. The water pump 318 is used to move the water 206 from the water reservoir 316 at high pressures, e.g., 300-400 kPa above operating pressure of the cathode.

An injection branch 322 is fluidically coupled at an output of the water pump 318 and is fluidically coupled to an injector 328. A valve 324 is coupled between the output of the water pump 318 and a return port 332 of the water reservoir 316. In a first position (a pass-through position), the valve 324 operates to permit the water flow within the recirculation branch 320 toward the return port 332 of the water reservoir 316. In a second position (a divert position), the valve 324 operates to prevent the water flow 206 output by the water pump 318 toward the return port 332 of the water reservoir 316 such that the flow 206 output by the water pump 318 is directed to supply the injector 328. Accordingly, the injector 328 introduces the water 206, now under high pressure, such as 300-400 kPa above operating pressure of the cathode, into the intake air stream 80. A check valve 326 coupled in the injection branch 322 is configured to prevent backflow of fluid toward the water pump 318.

In an example, as shown in FIG. 4, the humidification system 302 may include a controller 348 configured to monitor and control one or more components of the humidification system 302. The controller 348 may be communicatively coupled to, and configured to receive signals from, a plurality of sensors (not illustrated) of the air handling system 600 and/or the humidification system 302, such as, but not limited to, pressure sensors, temperature sensors, air flow sensors, oxygen sensors, and moisture sensors. The controller 348 may monitor and control operation of the water pump 318, the valve 324, and/or the injector 328 to perform one or more operations in accordance with the present disclosure. As just some examples, in response to one or more sensor signals indicating that temperature, pressure, or air flow parameter value is less than or greater than a predefined threshold value, the controller 348 may operate the valve 324 to transition from the first position to the second position and/or from the second position to the first position.

The condensation of exhaust water vapor 206, pressurization, and injection into the intake stream 80 of the fuel cell stack 12 is a continuous process which reoccurs simultaneously during fuel cell 20 operation. The controller 348 may be configured to control the amount of water 206 injected into the into the intake air stream 80 by the injector 328 by modulating the pressure of the water 206 at the injector 328 and/or by controlling duty cycle of the injector 328.

The controller 348 may modulate the speed of the water pump 318 to control water 206 pressure at the injector 328. Additionally or alternatively, a pressure regulator (not shown) coupled directly downstream of the water pump 318 may be configured to control pressure of the water 206 at the injector 328. In such an example, the controller 348 is configured to control one or both the pressure regulator and the water pump 318 to control the injector line 322 pressure and, by extension, achieve/establish the water 206 pressure at the injector 328 to be a predefined pressure value. The controller 348 modulates duty cycle of the injector 328 to control the mass flow of injected water 206 based on pressure of the injection branch 322 and dwell/open time of the injector 328.

The controller 348 may be configured to control pressure of the injection branch 322 such that the water 206 pressure within the injector 328 is greater than water 207 pressure of the intake air stream 80 in which it is being injected. To control the air temperature and vaporization %, the locations and injector style mentioned above can be used both individually or simultaneously, and/or done so in specific proportions (i.e., using both as the same time but with a 30-70% split) to accomplish the most favorable and repeatable outcome.

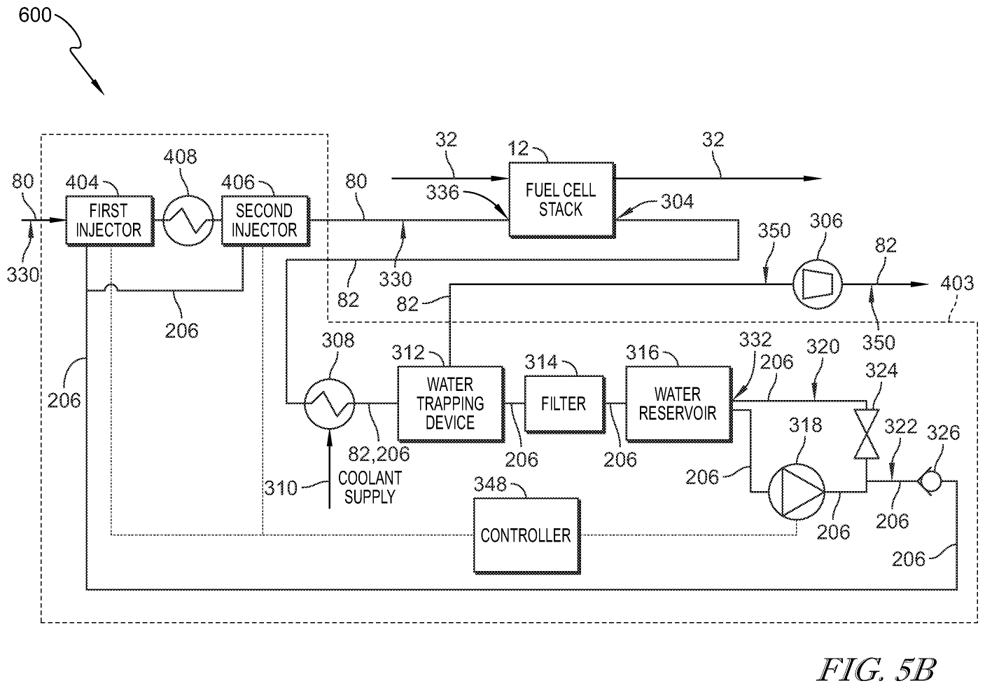

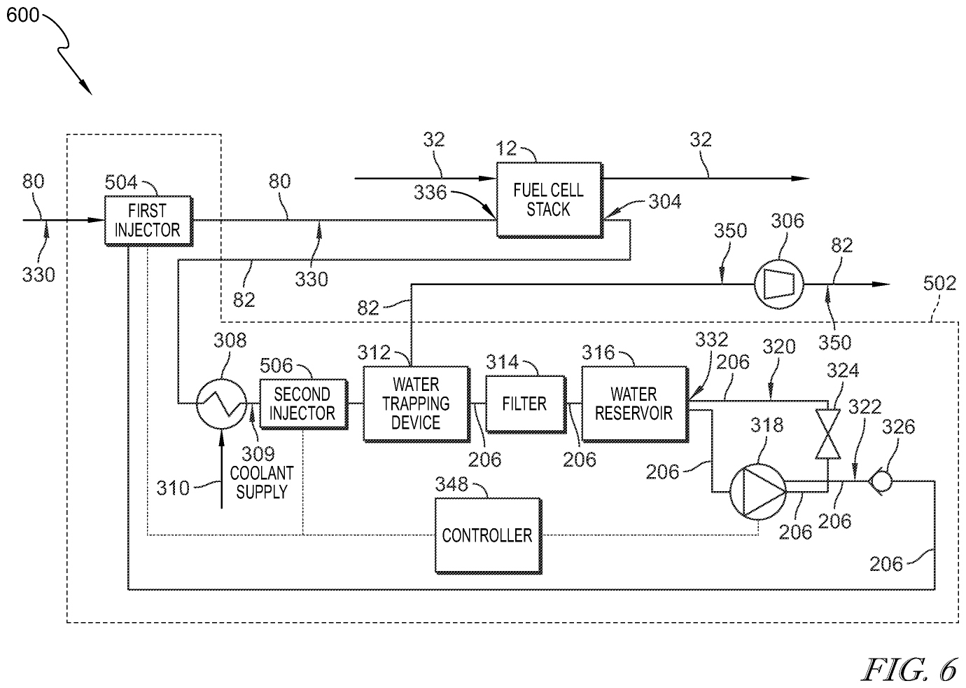

As illustrated in FIGS. 5A, 5B, and 6, a humidification system 402, 403, 502 in accordance with the present disclosure may include several injectors 404, 406, 504, 506. The humidification system 402, 403, 502 are substantially similar to the humidification system 302 discussed above. Accordingly, similar reference numbers are used to describe common features between humidification systems 402, 403, 502 and humidification system 302. The disclosure of humidification system 302 is incorporated by reference for humidification systems 402, 403, 502 except for differences discussed below. FIG. 5A illustrates an example implementation of humidification system 402 including a plurality of injectors 404, 406. The humidification system 402 includes a first injector 404 and a second injector 406 disposed in multiple locations within the inlet section 80 of the air handling system 600. FIG. 5B illustrates an example implementation of humidification system 403 including a charge air cooler 408 disposed between the first injector 404 and the second injector 406.

In the humidification systems 402, 403 of FIGS. 5A and 5B, The controller 348 may control the first injector 404 and the second injector 406 to selectively inject atomized liquid water 206 into the hottest process temperatures within the sequence of the components of the intake air branch 80 to provide a more complete vaporization of water 206 from the air stream 80 entering the fuel cell stack 12 at the cathode inlet 336. As one example, the controller 348 may activate the first injector 404 in response to temperature at the outlet of the compressor (not shown) being greater than temperature of the coolant 36, 310 circulating through the fuel cell stack 12, i.e., being greater than operating temperature of the fuel cell stack 12. As another example, the controller 348 may activate the second injector 406 in response to temperature at the outlet of the compressor being less than temperature of the coolant circulating through the fuel cell stack 12, i.e., being less than operating temperature of the fuel cell stack 12.

In some instances, applying injection to an air stream 80 having the highest temperature further supports that the injection is applied at a location with the lowest relative humidity. Further, injecting downstream from the air cooler 408 may result in lower relative humidity thereby increasing supply of water 206 available for injection, e.g., decrease relative humidity of the exhaust air stream 82 by an additional 5% makes possible 5% more water injection.

Additionally or alternatively, the controller 348 is configured to control the first injector 404 and the second injector 406 according to variance of the pressure mapping of the engine 100. In some instances, the controller 348 applies injection of the atomized liquid water 206 based on a pressure ratio, such that the controller 348 activates the injector 404 disposed upstream from the air cooler 408 in response to a pressure ratio greater than 1.5 and activates the injector 406 disposed downstream from the air cooler 408 in response to pressure ratio being less than 1.5 as shown in FIG. 5B.

One or more injectors 404, 406 may be fluidically coupled downstream from an outlet of the compressor and/or upstream from the charge air cooler 408 or recuperator. The compression stage produces considerable heat at high pressure ratios, e.g., pressure ratios greater than 1.75 times the compressor inlet pressure. The heat output by the compression stage may be leveraged to vaporize the water 206 content introduced into the intake air stream 80 by the one or more injectors 404, 406 disposed downstream of the compression stage. The air handling system section (not shown) at the outlet of the compressor upstream of the charge air cooler 408 may be a hottest section of the air stream 80 and, therefore, most likely to achieve a nearly complete vaporization. Further, using evaporative cooling to lower the charge air temperature may reduce the heat transfer requirements for, and/or entirely remove a need for, one or more coolers 408 disposed further downstream.

FIG. 6 illustrates an example implementation of humidification system 502 including one or more injectors 504, 506 fluidically coupled downstream from the heat exchanger 308. As just one example, the humidification system 502 includes a first injector 504 coupled to humidify intake air stream 80. The humidification system 502 includes a second injector 506 fluidically coupled to an outlet 309 of the heat exchanger 308 and configured to selectively humidify air stream 82 output by the heat exchanger 308. At a time in an operating cycle of the fuel stack 12 when the compressor stage may not produce sufficient amount of heat, such as in a low or moderate pressure operating mode, e.g., approximately 1.2 times the atmospheric pressure, excess heat output by the heat exchanger 308 may achieve a more complete vaporization of water 206 introduced by the second injector 506 than a smaller amount of heat output by the compressor stage, if the humidification by the first injector 504 was to be used.

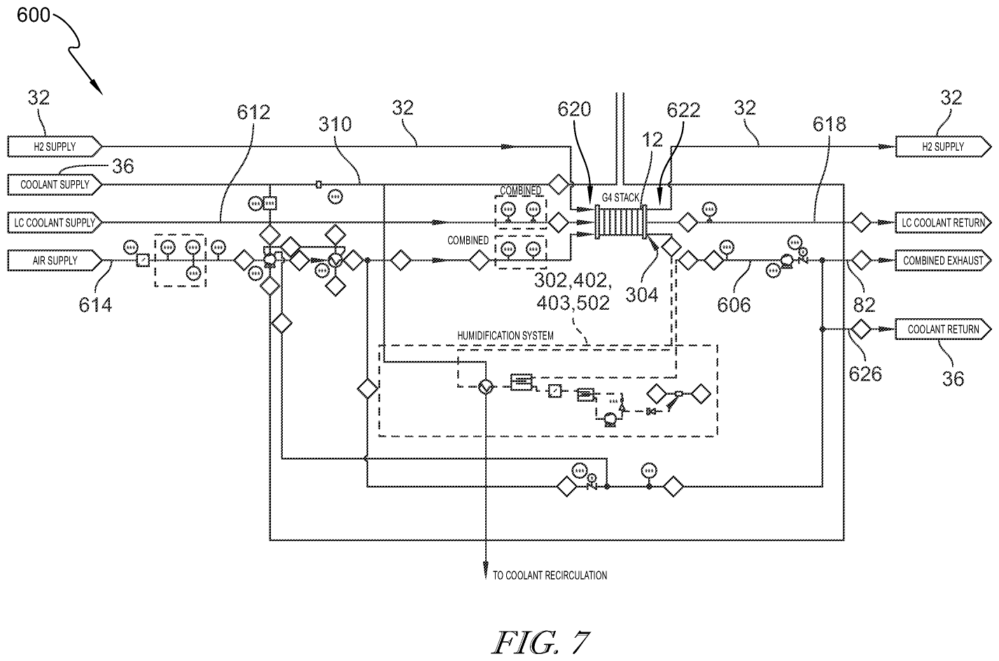

FIG. 7 illustrates an example air handling system 600 including a humidification system 302, 402, 403, 502. The humidification system 302, 402, 403, 502 is fluidically coupled between a cathode exhaust outlet 304 of the fuel cell stack 12 and a cathode exhaust line 606. The air handling system 600 includes a plurality of supply lines coupled to an input side 620 of the fuel cell stack 12. The plurality of supply lines are configured to deliver one of air 80, coolant 36, hydrogen 32 or another fuel substance or gas to the fuel cell stack 12 and include, but are not limited to, a hydrogen supply line 32, a coolant supply line 310, an LC coolant supply line 612, and an air supply line 614. A plurality of return lines couples to an output side 622 of the fuel cell stack 12. The plurality of return lines are configured to evacuate, recirculate, or otherwise remove one of exhaust air 82, exhaust coolant 36, hydrogen 32 or another fuel substance or gas from the fuel cell stack 12 and include, but are not limited to, a hydrogen supply output line 32, an LC coolant return line 618, a combined exhaust return line 82, and a coolant return line 626.

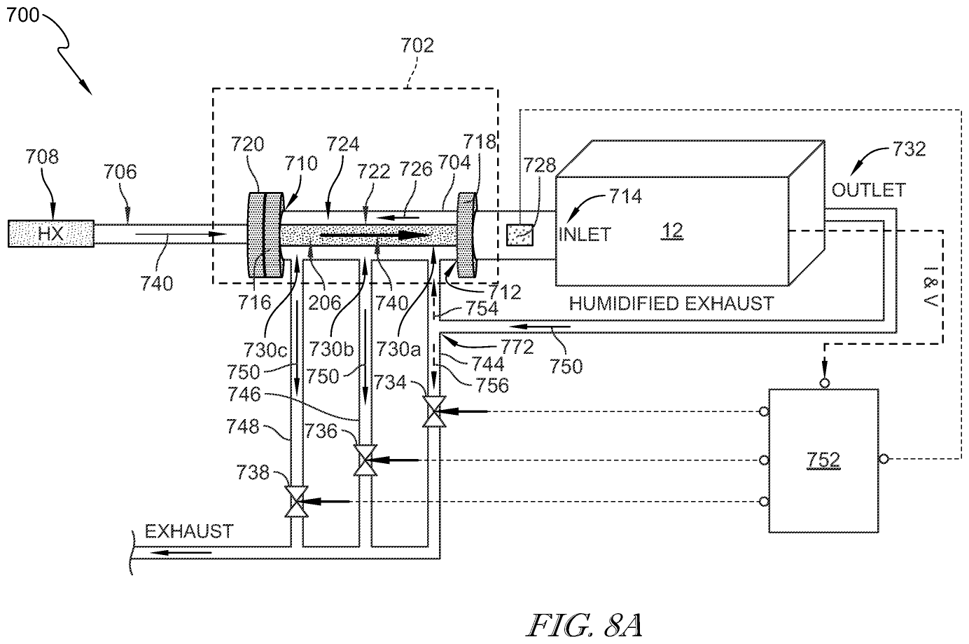

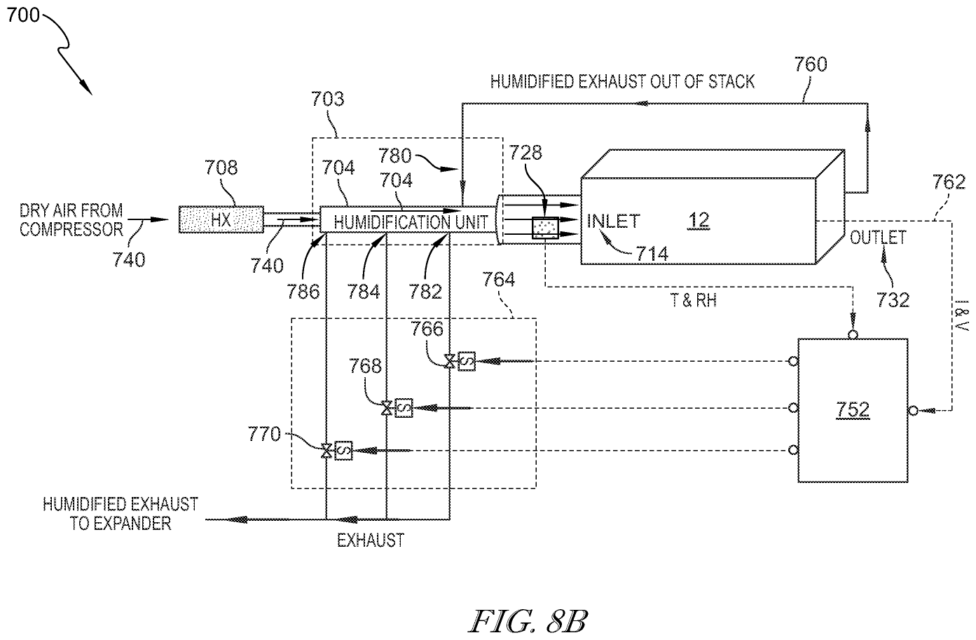

FIG. 8A illustrates an example implementation a humidification system 702 within air system 700 in accordance with the present disclosure. The air system 700 is substantially similar to air system 600 discussed above. Accordingly, similar reference numbers are used to describe common features between air system 700 and air system 600. The disclosure of air system 600 is incorporated by reference for air system 700 except for differences discussed below. The humidification system 702 includes a humidification system housing 704 having two opposing ends 710 and 712, where the first end 710 of the housing 704 is configured to couple, for example, downstream from a heat exchanger 708 and the second end 712 of the housing 704 is configured to couple to an inlet 714 of the fuel cell stack 12. The humidification system housing 704 receives intake air 740 output by the heat exchanger 708 and directs the received air 740 toward the inlet 714 of the fuel cell stack 12.

In an example, the housing 704 may be shaped as an elongated circular tube (e.g., a tube having a circular cross-section). In other examples, the housing 704 may be a rectangular (including square) tube, a triangular tube, a pentagonal tube, an oval tube, and so on. In still another example, a shape of interior and exterior walls of the housing 704 may be the same with one another. In yet another example, a shape of interior walls of the housing 704 may be different from a shape of exterior walls of the housing 704, such that exterior walls of the housing 704 may be circular in cross-section and interior walls of the housing 704 may be one triangular, rectangular, pentagonal, and oval, and vice versa, or any combination of these or other shapes.

In one example, the housing 704 of the humidification system 702 includes a first flange 716 about the first end 710 and a second flange 718 about the second end 712. The first flange 716 of the housing 704 mechanically and fluidically cooperates with a corresponding flange 720 coupled to a pipe or another conduit 706 downstream from the heat exchanger 708. While the housing 704 of the humidification system 702 is illustrated as being coupled to an outlet of the heat exchanger 708, the humidification system 702 of the present disclosure is not limited thereto. In other examples, the housing 704 may be coupled fluidically upstream or downstream from one or more additional or different components of an intake air recirculation subsystem and/or an exhaust air recirculation subsystem of the fuel cell stack 12.

The housing 704 includes a tubular mass exchanger 722 disposed interior to and concentrically with the housing 704, such that a void 724 is created between inner walls of the housing 704 and outer walls of the tubular mass exchanger 722. Properties of the material of the tubular mass exchanger 722 may include being highly selective with respect to water and/or being impermeable to gases. In one example, material of the tubular mass exchanger 722 may be include a polymer, such as, for example, a sulfonated perfluoro polymer and a sulfonated hydrocarbon polymer. As another example, the material of the tubular mass exchanger 722 may be resin.

An opening at an end of the tubular mass exchanger 722 is aligned with an opening of the pipe 706 downstream from the heat exchanger 708. The tubular mass exchanger 722 receives air output 740, for example, by the heat exchanger 708. The air 740 flowing through the tubular mass exchanger 722 interacts with humidified exhaust 726 circulated within or transferred through the void 724, such that the tubular mass exchanger 722 separates, isolates, and/or transfers/removes a predefined amount of water vapor 206 from the humidified exhaust 726 and to the air 740 flowing through the tubular mass exchanger 722. Put another way, the two fluids flow near one another with a high surface area-to-volume ratio in order to efficiently transfer energy between each other.

The tubular mass exchanger 722 may wick away and transfer a predefined amount of water vapor 206 from a first substance or fluid to a second substance or fluid. In an example, the tubular mass exchanger 722 may cause the transfer of water vapor 206 between two substances having a predefined difference between a first relative humidity of the first substance and a second relative humidity of a second substance. In some instances, the first substance may be intake air 740 circulated within or transferred through the tubular mass exchanger 722 and the second substance may be humidified exhaust air stream 726 circulated within or transferred through the void 724 between outer walls of the tubular mass exchanger 722 and inner walls of the housing 704 that houses the tubular mass exchanger 722. The received intake air 740 is humidified by this heat exchange process prior to entering the fuel cell stack 12 via the inlet 714.

Walls of the housing 704 define one or more openings 730, e.g., openings 730a, 730b, and 730c, where each opening 730 is one of an entry opening and an exit opening. As just one example, humidified exhaust air 750 may enter the void 724 using a first opening 730a and may exit the void 724 using one or both of a second opening 730b and a third opening 730c. As another example, the openings 730 may be disposed on the walls of the housing 704 in a predefined manner with respect to the tubular mass exchanger 722, with respect to the inlet 714 of the fuel cell stack 12, and/or with respect to one another. Put another way, the openings 730 are disposed with respect to one another such that, depending on which of the openings 730 is/are actively supporting entry and exit of the humidified exhaust air 750 into/from the void 724, a varying portion or a varying amount of a surface area of the tubular mass exchanger 722 becomes exposed to the humidified exhaust air 750 to facilitate the mass exchange between the humidified exhaust air stream 750 and the intake air 740 flowing through the tubular mass exchanger 722. In this manner, different amounts of water vapor 206 may be directed from the humidified exhaust air 750 drawn through the void 724 and introduced or transferred into the intake air stream 740 flowing through the interior of the tubular mass exchanger 722. Accordingly, the housing 704 and the tubular mass exchanger 722 support varying degrees of humidification of the intake air 740 by water vapor 206 extracted or wicked away from the humidified exhaust air stream 750.

As an example, the first opening 730a of the plurality of openings 730 may be disposed closest to the second end 712 of the housing 704 and/or closest to the inlet 714 of the fuel cell stack 12. As another example, the third opening 730c of the plurality of openings 730 may be disposed closest to the first end 710 of the housing 704 and/or closest to the heat exchanger 708 disposed upstream from the humidification system 702 and/or farthest from the inlet 714 of the fuel cell stack 12. As still another example, the second opening 730b of the plurality of openings 730 may be disposed between the first opening 730a and the third opening 730c (e.g., upstream from the first opening 730a and downstream from the third opening 730c).

FIG. 12 illustrates example reference point diagram 1100 for implementing the humidification system 702 in accordance with the present disclosure. In an example, a magnitude of a first distance x between a center of the first opening 730a and the second end 712 of the housing 704 may be less/smaller than a magnitude of a second distance y between a center of the second opening 730b and the second end 712 of the housing 704. In another example, the magnitude of the second distance y between the center of the second opening 730b and the second end 712 of the housing 704 may be less/smaller than a magnitude of a third distance z between a center of the third opening 730c and the second end 712 of the housing 704.

Additionally or alternatively, a magnitude of a fourth distance p extending between corresponding centers of the first opening 730a and the second opening 730b may be less/smaller than a magnitude of a fifth distance q extending between corresponding centers of the first opening 730a and the third opening 730c. Still further, a magnitude of the fourth distance p may be same as, or different from, a sixth distance s extending between corresponding centers of the second opening 730b and the third opening 730c.

As described above, the first, second, third, fourth, fifth, and sixth distances x, y, z, p, q, and s provide varying a portion or varying an amount of a surface area of the tubular mass exchanger 722 exposed to the humidified exhaust air 750 to facilitate the mass exchange between the humidified exhaust air stream 750 and the intake air 740 flowing through the tubular mass exchanger 722. In this manner, different amounts of water vapor may be directed from the humidified exhaust air 750 drawn through the void 724 and introduced or transferred into the intake air stream 740 flowing through the interior of the tubular mass exchanger 722.

While three openings 730 are illustrated in FIGS. 8A, 8B and 12, the humidification system 702 is not limited thereto. Example implementations of the housing 704 may define any number of openings 730, such as one opening 730 or any number of openings 730 greater than one. Moreover, the openings 730 may be different in size (e.g., as measured using one of a length of the opening 730, a width of the opening 730, a radius of the opening 730, a diameter of the opening 730, a circumference of the opening 730, or some combination thereof) from that of one another to provide refined control of the humidification of the intake air 740 in accordance with the present disclosure.

Referring to FIG. 8A, one of a plurality of conduits 744, 746, and 748 may couple to the wall of the housing 704 about each of the openings 730. As just one example, a first conduit 744 is coupled to the wall of the housing 704 about the first opening 730a and configured to direct humidified exhaust air stream 750 through the first opening 730a and toward the void 724 within the housing 704. Under predefined operating conditions, the first conduit 744 is configured to cause the humidified exhaust air stream 750 to bypass entering the void 724 of the housing 704. Whether directing the humidified exhaust air stream 750 into the void 724 of the housing 704 or directing the humidified exhaust air stream 750 to bypass the housing 704, the first conduit 744 may be fluidically coupled to the outlet 732 of the fuel cell stack 12 to receive the humidified exhaust air stream 750 therefrom. In one example, the exhaust air stream outlet 732 is fluidically coupled to the first conduit 744 via a T-junction 772, such that directing, in a first direction 754, the flow of the humidified exhaust air 750 from the T-junction 772 and through the first conduit 744 causes the humidified exhaust air 750 to enter the void 724 within the housing 704 and directing, in a second direction 756, the flow of the humidified exhaust air 750 from the T-junction to bypass the housing 704.

As another example, a second conduit 746 is coupled to the wall of the housing 704 about the second opening 730b and configured to direct humidified exhaust air stream 750 through the second opening 730b and away from the void 724 of the housing 704. As still another example, a third conduit 748 is coupled to the wall of the housing 704 about the third opening 730c and configured to withdraw humidified exhaust 750 from the housing 704 by directing the exhaust air stream 750 through the third opening 730c and away from the void 724 of the housing 704. The fuel cell stack 12 outputs exhaust air stream 750 via the exhaust air outlet 732.

A plurality of valves 734, 736, 738 are fluidically coupled to the plurality of conduits 744, 746, and 748 to activate and deactivate a flow of the humidified exhaust air stream 750 into and out of the housing 704 (e.g., via one or more of the openings 730) to control humidification of the intake air stream 740 by water vapor 206 wicked away from the humidified exhaust air stream 750. For example, a first valve 734 is fluidically coupled to the first conduit 744 to control flow of the humidified exhaust air stream 750 into the housing 704 and/or to bypass the housing 704. When the first valve 734 is in a first position, e.g., closed, the humidified exhaust air stream 750 is directed into the void 724 of the housing 704 and, when the first valve 734 is in a second position, e.g., open, to bypass the housing 704.

As another example, a second valve 736 is fluidically coupled to the second conduit 746 to control flow of the humidified exhaust air stream 750 from within the housing 704 and out of and away from the housing 704. As still another example, a third valve 738 is fluidically coupled to the third conduit 748 to control flow of the humidified exhaust air stream 750 from within the housing 704 and out of and away from the housing 704. Opening the second valve 736 and/or the third valve 738 causes the exhaust air stream 750 present within the void 724 of the housing 704 to be drawn along at least a portion of the surface area of the tubular mass exchanger 722 and from the housing 704.

In other words, each of the valves 734, 736, and 738 is configured to one of direct the exhaust air stream 750 to bypass humidifying the intake air stream 740 and to direct the exhaust air stream 750 to humidify the intake air stream 740. Still further, the valves 734, 736, 738 are configured to vary (e.g., increase or decrease) the amount of water vapor wicked away from the exhaust air stream 750 to humidify the intake air stream 740. In an example, each of the valves 734, 736, 738 may be fluidically coupled to activate and deactivate one or more of the openings 730 to facilitate humidification (or to facilitate bypassing of humidification) of the intake air stream 740 by water vapor 206 extracted from the exhaust air stream 750.

A sensor 728 is disposed at the output end 712 of the housing 704. The sensor 728 detects humidity and temperature of the intake air 740 that passed through the tubular mass exchanger 722 and is being directed to the inlet 714 of the fuel cell stack 12. A controller 752 is communicatively coupled to receive signals from the sensor 728 and is configured to control the plurality of valves 734, 736, 738 to open and close based on the signals of the sensor 728. For example, the controller 752 may be configured to, in response to a corresponding signal from the sensor 728, command at least one of the plurality of valves 734, 736, 738 to open or close to humidify the exhaust air stream 750 using the moisture extracted from the intake air 740. In another example, the controller 752 is configured to command at least one of the plurality of valves 734, 736, 738 to open or close to prevent humidification of the exhaust air stream 750 using the moisture extracted from the intake air 740, i.e., such that the exhaust air stream 750 bypasses humidification process.

FIG. 8B illustrates an example implementation of humidification system 703 in accordance with the present disclosure. The humidification system 703 is substantially similar to humidification system 702 discussed above. Accordingly, similar reference numbers are used to describe common features between humidification system 702 and humidification system 703. The disclosure of humidification system 702 is incorporated by reference for humidification system 703 except for differences discussed below. In one example, dry and pressurized air 740 from a compressor (not illustrated) is cooled down using the heat exchanger 708 to a predefined operating temperature of the fuel cell stack 12. The intake air 740 output by the heat exchanger 708 passes through the humidification system 703.

In some instances, the humidification system 703 is mechanically and fluidically connected to, e.g., via an inlet opening 780 in the wall of the housing 704, an exhaust stream outlet 732 of the fuel cell stack 12 and configured to receive exhaust air stream 760 output by the fuel cell stack 12. Walls of the housing 704 of the humidification system 702 may define a plurality of outlet openings 782, 784, 786, such that the humidified exhaust air stream 760 exits the interior of the housing 704. Each outlet opening may be connected to one of a plurality of valves 766, 768, 770 of a valve unit 764. In some examples, the inlet opening 780 is disposed such that the humidified exhaust air stream 760 enters interior of the housing 704 downstream from each of the openings 782, 784, 786, such that amount of water vapor 206 transferred from the humidified exhaust air 760 to the intake air stream 740 by the tubular mass exchanger 722 is controlled by controlling amount of surface area of the tubular mass exchanger 722 being exposed to the humidified exhaust air 760.

In some other examples, a first outlet opening 782 may be a bypass opening and may be disposed immediately upstream from the inlet opening 780. In such an example, the first outlet opening 782 may be coupled to a first valve 766 (a bypass valve) of the plurality of valves 766, 768, 770 and the controller 752 may be configured to command the first valve 766 to open such that the humidified exhaust air stream 760 bypasses interacting with the surface area of the tubular mass exchanger 722 to humidify the intake air stream 740 passing through the interior of the tubular mass exchanger 722 prior to entering the inlet 714 of the fuel cell stack 12.

A second outlet opening 784 may be disposed upstream from the first opening 782 and may be coupled to a second valve 768 of the plurality of valves 766, 768, 770. The controller 752 may be configured to command the second valve 768 to open (and/or command the first valve 766 to close) such that the humidified exhaust air stream 760 interacts with the surface area of the tubular mass exchanger 722 to humidify, by a first predefined amount, the intake air stream 740 passing through the interior of the tubular mass exchanger 722. In still another example, a third outlet opening 786 may be disposed upstream from the second opening 784 and may be coupled to a third valve 770 of the plurality of valves 766, 768, 770. The controller 752 may be configured to command the third valve 770 to open (and/or command the first valve 766 and/or the second valve 768 to close) such that the humidified exhaust air stream 760 interacts with a predefined surface area of the tubular mass exchanger 722 to humidify, by a second predefined amount, the intake air stream 740 passing through the interior of the tubular mass exchanger 722, wherein the second predefined amount is greater than the first predefined amount. In some instances, a difference between the first predefined amount and the second predefined amount may correspond to a distance between the second outlet opening 784 and the third outlet opening 786 and/or correspond to a difference in the surface area of the tubular mass exchanger 722 exposed to the humidified exhaust stream 760 prior to the exhaust air stream 760 exiting the void 724 of the housing 704.

Upon exiting the humidification system 703, the air stream 740 passes through a relative humidity and temperature (RHT) sensor 728 configured to measure both a relative humidity and a temperature of the air stream at the inlet 714 of fuel cell stack 12. The controller 752 is communicatively coupled to the relative humidity and temperature sensor 728 and configured to receive one or more signals therefrom indicating relative humidity and temperature of the air stream 740 measured at the inlet 714 to the fuel cell stack 12. The controller 752 is communicatively coupled to receive one or more signals 762 indicating current and voltage output by the fuel cell stack 12 when provided with the air stream 740 having previously measured relative humidity and temperature values.

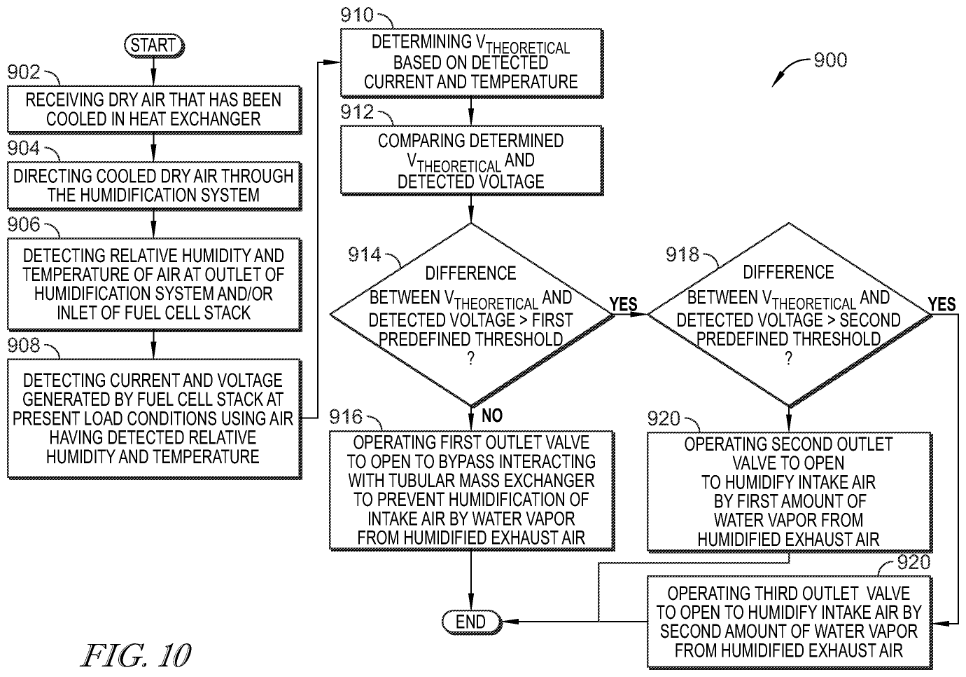

In an example, the controller 752 may be configured to determine a theoretical voltage V_{THEORETICAL} based on the measured relative humidity and temperature of the air stream 740 at the inlet 714 of the fuel cell stack 12. The controller 752 may then compare the determined theoretical voltage V_{THEORETICAL} to an actual voltage value generated or output by the fuel cell stack 12. The controller 752 may be configured to operate one or more of the valves 766, 768, and 770 to open and/or close based on a difference between the determined theoretical voltage V_{THEORETICAL} and the actual voltage value. As described in reference to at least FIG. 10, the controller 752 may control one or more valves 766, 768, and 770 to humidify or to prevent humidifying (e.g., bypass humidifying) intake air stream directed toward the inlet of the fuel cell stack 12 based on whether the difference between the determined theoretical voltage V_{THEORETICAL} and the actual voltage value is greater than a predefined threshold.

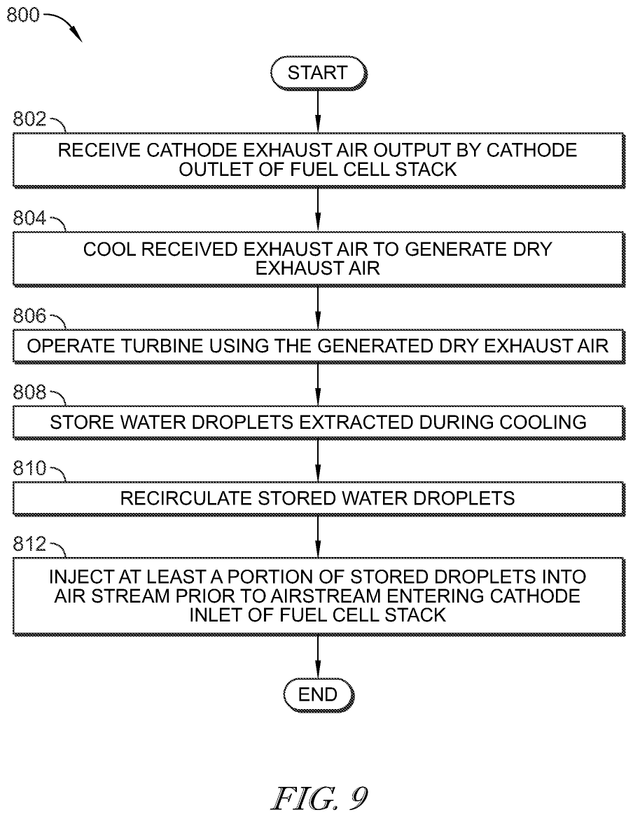

FIG. 9 is a flowchart illustrating an example process 800 for humidifying the fuel cell 20 of FIG. 1C. One or more operations of the process 800 may be performed by one or more components of the systems 100 and 600 of FIGS. 2, 3A-3B, 4, 5A-5B, 6, and 7, respectively, such as, but not limited to, the turbine 306, the valve 324, the injector 328, the water trapping device 312, the water reservoir 316, the controller 348, the injectors 404, 406, and the injectors 504, 506.

The process 800 includes, at block 802, receiving cathode exhaust air 82 output by a cathode outlet 304 of the fuel cell stack 12. At block 804, the process 800 includes cooling received exhaust air 82 to generate dry exhaust air 82. The process 800 further includes, at block 806, operating a turbine 306 using the generated dry exhaust air 82. At block 808 of the process 800 includes storing the water droplets 206 extracted during cooling. The process 800 includes recirculating, at block 810, the stored water droplets 206. At block 812, the process 800 includes injecting at least a portion of the stored droplets 206 into the air stream 80 prior to the air stream 80 entering cathode inlet 336 of the fuel cell stack 12. The process 800 may then end. In other instances, the process 800 may be repeated in response to cathode exhaust air 82 being output by cathode outlet 304 of the fuel cell stack 12.

FIG. 10 is a flowchart illustrating another example process 900 for humidifying the fuel cell of FIG. 1C. One or more operations of the process 900 may be performed by one or more components of the systems 700, 1000, and 1100 of FIGS. 1C, 2, 8A, 8B, 11, and 12, respectively, such as, but not limited to, the humidification system 702, 703, the housing 704, the tubular mass exchanger 722, the sensor 728, the valves 734, 736, and 738, the valve unit 764, the valves 766, 768, and 770, and the controller 752.

The process 900 includes, at block 902, receiving intake air stream 740 output by the heat exchanger 708. At block 904, the process 900 includes directing the received intake air stream 740 through the humidification system 702, 703 in accordance with the present disclosure. The process 900, at block 906, includes detecting relative humidity and temperature of air 740 at the outlet of the humidification system 702, 703 and/or the inlet 714 of the fuel cell stack 12. At block 908, the process 900 includes detecting current and voltage generated by the fuel cell stack 12 using air 740 having previously detected relative humidity and temperature. The controller 752 determines, at block 910, a theoretical voltage V_{THEORETICAL} based on the detected current generated by the fuel cell stack 12 and the measured temperature at the inlet 714 of the fuel cell stack 12. At block 912, the controller 752 compares the theoretical voltage V_{THEORETICAL} and the actual voltage value.

At block 914, the controller 752 determines whether a difference between the theoretical voltage V_{THEORETICAL} and the actual voltage value is greater than a first predefined threshold. In response to the difference between the theoretical voltage V_{THEORETICAL} and the actual voltage value being less than a first predefined threshold, the controller 752, at block 916, operates to open the first outlet valve 734, 766 to bypass interacting humidified exhaust air 750, 760 with the surface area of the tubular mass exchanger 722 to prevent humidification of intake air 740 passing through the tubular mass exchanger 722 by water vapor 206 of the humidified exhaust air stream 750, 760. The controller 752 may then end the process 900.

In response to the difference between the theoretical voltage V_{THEORETICAL} and the actual voltage value being greater than a first predefined threshold, the controller 752, at block 918, determines whether the difference between the theoretical voltage V_{THEORETICAL} and the actual voltage value being greater than a second predefined threshold, where the second predefined threshold is greater than the first predefined threshold. If the difference between the theoretical voltage V_{THEORETICAL} and the actual voltage value is less than a second predefined threshold, the controller 752, at block 920, operates to open the second outlet valve 736, 768 to transfer a first predefined amount of water vapor 206 from the humidified exhaust air 750, 760 to the intake air 740 passing through the interior of the tubular mass exchanger 722 by exposing a first predefined surface area of the tubular mass exchanger 722 to the humidified exhaust air stream 750, 760. If the difference between the theoretical voltage V_{THEORETICAL} and the actual voltage value is greater than a second predefined threshold, the controller 752, at block 922, operates to open the third outlet valve 770 to transfer a second predefined amount of water vapor 206 from the humidified exhaust air 750, 760 to the intake air 740 passing through the interior of the tubular mass exchanger 722 by exposing a second predefined surface area of the tubular mass exchanger 722 to the humidified exhaust air stream 750, 760, where the second predefined amount is greater than the first predefined amount and/or the second surface area is greater than the first surface area. The process 900 may then end. In other instances, the process 900 may be repeated in response to intake air stream 740 being received from the heat exchanger 708.

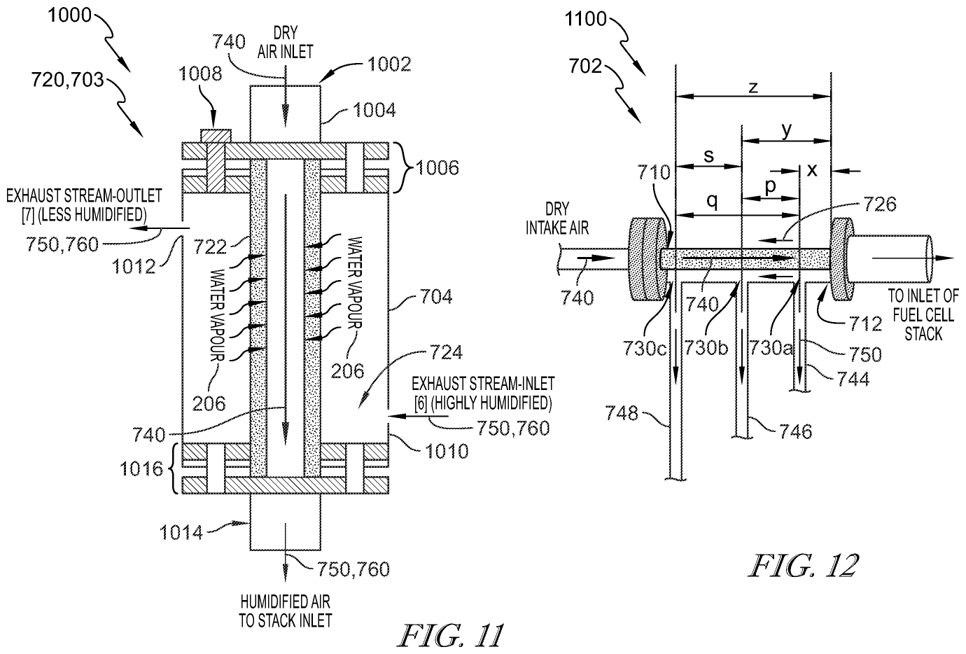

FIG. 11 illustrates a top view of an example implementation 1000 of the humidification system 702, 703 including the tubular mass exchanger 722, as described in reference to at least FIGS. 8A-8B, 10, and 12. Dry intake air 740 may enter the tubular mass exchanger 722 of the humidification system 702 via an inlet opening 1002.

The tubular mass exchanger 722 may be a hollow tubular structure made of polymer or resin material, such as, but not limed to, perfluorosulfonic acid (PFSA) polymer and a sulfonic hydrocarbon polymer. Material of the tubular mass exchanger 722 facilitates exchange of humidity or moisture, or water vapor, and/or prevents passing of (impermeable to) gases. The tubular mass exchanger 722 may be coupled to the housing 704 using a connector (not shown), such as, for example, a Swagelok connector. In some instances, a thickness of walls of the tubular mass exchanger 722 may be within a range between, and including, 200 μm and 1 mm.

The tubular mass exchanger 722 is housed within the housing 704. The housing 704 may be metal, pure or alloy, such as, for example, steel, aluminum, titanium, iron, copper, silver, mercury, lead, gold, platinum, zinc, nickel, and tin. The housing 704 is coupled to an intake air delivery pipe 1004 via a flange coupling 1006 and one or more coupling mechanisms 1008, such as, bolts. A high-pressure device may be disposed to reduce or minimize a potential leak at the coupling surfaces of the flange coupling 1006 and the one or more coupling mechanisms 1008. The tubular mass exchanger 722 may be straight or helical.

Walls of the housing 704 define an inlet opening 1010 and an outlet opening 1012. In one example, highly humidified exhaust stream 750, 760 from the fuel cell stack 12 enters the housing 704 via the inlet opening 1010 and fills the void 724 (e.g., space) between an outer wall of the tubular mass exchanger 722 and the inner wall of the housing 704. As another example, exhaust stream 750, 760 leaves through the outlet opening 1012.

Dry intake air 740 transferred through an interior of the tubular mass exchanger 722 absorbs water vapor 206 separated from the humidified exhaust stream 750, 760 via exterior walls of the tubular mass exchanger 722. Water vapor 206 exchanged between the dry intake air stream 740 and the humidified exhaust stream 750, 760 occurs via a convective and/or diffusion mechanism. The humidified intake air 750, 760 exits the humidification system 702, 703 and is directed toward the inlet port of the fuel cell stack 12 via an exit pipe or steel tube 1014 with an exit flange coupling 1016.

The following described aspects of the present invention are contemplated and non-limiting:

A first aspect of the present invention relates to a humidification system. The humidification system comprises a heat exchanger, a water trapping device, and an injector. The heat exchanger is fluidically coupled to a cathode outlet of a fuel cell stack to receive exhaust air stream therefrom and to cool the received exhaust air stream. The water trapping device is fluidically coupled to the heat exchanger and is configured to trap water droplets extracted from the exhaust air stream by the heat exchanger to generate a dry exhaust air stream. The injector is fluidically coupled to the water trapping device and is configured to receive at least a portion of the water droplets trapped by the water trapping device. The injector is also fluidically coupled upstream from a cathode inlet of the fuel cell stack and is configured to humidify a stream of air using the received portion of the water droplets prior to the stream of air entering the cathode inlet.

A second aspect of the present invention relates to a method for humidifying a fuel cell of a fuel cell system. The method includes the steps of receiving exhaust air stream from a cathode outlet of a fuel cell stack and cooling the received exhaust air stream, trapping water droplets extracted from the exhaust air stream to generate a dry exhaust air stream, and receiving at least a portion of the water droplets and humidifying a stream of air using the received portion of the water droplets prior to the stream of air entering a cathode inlet of the fuel cell stack.

A third aspect of the present invention relates to a fuel cell system. The fuel cell system comprises a fuel cell stack, a heat exchanger, a water trapping device, and an injector. The fuel cell stack has a cathode inlet and a cathode outlet. The fuel cell stack is configured to use the cathode inlet to receive intake air stream therethrough and use the cathode outlet to output exhaust airstream therethrough. The heat exchanger is fluidically coupled to the cathode outlet of the fuel cell stack to receive the exhaust air stream therefrom and to cool the received exhaust air stream. The water trapping device is fluidically coupled to the heat exchanger and is configured to trap water droplets extracted from the exhaust air stream by the heat exchanger by the heat exchanger to generate a dry exhaust air stream. The injector is fluidically coupled to the water trapping device and is configured to receive at least a portion of the water droplets trapped by the water trapping device. The injector is also fluidically coupled upstream from the cathode inlet of the fuel cell stack and is configured to humidify a stream of air using the received portion of the water droplets prior to the stream of air entering the cathode inlet.

A fourth aspect of the present invention relates to a humidification device. The humidification device comprises a tubular mass exchanger and a housing. The tubular mass exchanger is fluidically coupled to receive intake air stream and transfer intake air stream to an intake air inlet of a fuel cell stack. The housing is configured to house the tubular mass exchanger to define a void therebetween. The housing defines at least one housing inlet opening fluidically coupled to direct an exhaust air stream output by the fuel cell stack into the void. The housing also defines at least one housing outlet opening fluidically coupled to direct the exhaust air stream away from within the housing. The tubular mass exchanger is configured to extract water vapor from the exhaust air stream and transfer the extracted water vapor to the intake air stream flowing from within the tubular mass exchanger to humidify the intake air stream to generate a humidified intake air stream.

A fifth aspect of the present invention relates to a humidification system of a fuel cell system. The system comprises a humidification device, a plurality of valves, and a controller. The humidification device includes a housing and a tubular mass exchanger disposed within the housing. The humidification device is coupled to an inlet port of a fuel cell stack to humidify an intake air stream transferred through the tubular mass exchanger prior to entering the inlet port. The plurality of valves is fluidically coupled to the housing to control flow of an exhaust air stream output by the fuel cell stack through the housing. The controller is communicatively coupled to command each of the plurality of valves to open and close. The controller is configured to, in response to humidity of the intake air stream at the intake air inlet being less than a predefined threshold, operate at least one of the plurality of valves to close to humidify the intake air stream using the water vapor extracted from the exhaust air stream to generate a humidified intake air stream.

In the first and third aspect of the present invention, the system may further comprise a turbine fluidically coupled to receive the dry exhaust air stream output by the water trapping device.

In the first and third aspect of the present invention, the system may further comprise a fluid reservoir fluidically coupled between the water trapping device and the injector. The fluid reservoir may be configured to receive and store the water droplets from the water trapping device. The fluid reservoir may be configured to selectively provide at least the portion of the water droplets to the injector. In the first and third aspect of the present invention, the system may further comprise a pump fluidically coupled between an outlet port of the fluid reservoir and a return port of the fluid reservoir. The pump may be configured to recirculate the water droplets output at the outlet port of the fluid reservoir toward the return port of the fluid reservoir. In the first and third aspect of the present invention, the system may further comprise a valve coupled between an outlet of the pump and the return port of the fluid reservoir.

The valve may be configured to operate in a first position to permit flow of water output by the pump toward the return port and in a second position to prevent the flow of water toward the return port. In the first and third aspect of the present invention, the system may further comprise an injection branch fluidically coupled between the outlet of the pump and the valve. The injector may be coupled to the injection branch to receive at least the portion of the water droplets via the injection branch. In the first and third aspect of the present invention, the injector may be configured to receive at least the portion of the water droplets by the injection branch in response to the valve being in the second positon.

In the first and third aspect of the present invention, the system may further comprise a filter fluidically coupled between the water trapping device and the fluid reservoir. The filter may be configured to filter the water droplets output by the water trapping device.

In the second aspect of the present invention, the method may further comprise the step of operating a turbine using the dry exhaust air stream. In the second aspect of the present invention, the method may further comprise, prior to receiving at least the portion of the water droplets and humidifying the stream of air, the step of storing the water droplets. In the second aspect of the present invention, the method may further comprise the step of recirculating the stored water droplets.

In the fourth aspect of the present invention, an amount of water vapor extracted from the exhaust air stream and transferred to the intake air stream flowing within the tubular mass exchanger may be based on a difference in a first relative humidity of the exhaust air stream and a second relative humidity of the intake air stream. In the fourth aspect of the present invention, an amount of water vapor extracted from the exhaust air stream may correspond to a portion of a surface area of the tubular mass exchanger interacting with the exhaust air stream prior to exhaust air stream exiting the void.

In the fourth aspect of the present invention, the at least one housing outlet opening may be a first housing outlet opening. The exhaust air stream may interact with a first portion of the surface area of the tubular mass exchanger prior to exiting the void through the first housing outlet opening. The housing may define a second housing outlet opening. The exhaust air stream may interact with a second portion of the surface area of the tubular mass exchanger prior to exiting the void through the housing outlet opening. In the fourth aspect of the present invention, the second portion may be greater than the first portion. In the fourth aspect of the present invention, the tubular mass exchanger may extract a first amount of water vapor from the exhaust air stream prior to the exhaust air stream exiting the void through the first housing outlet opening.

The tubular mass exchanger may extract a second amount of water vapor from the exhaust air stream prior to the exhaust air stream exiting the void through the second housing outlet opening. The second amount may be greater than the first amount. In the fourth aspect of the present invention, the at least one housing inlet opening may be disposed immediately upstream from the intake air inlet of the fuel cell stack, the first housing outlet opening may be disposed upstream from the at least one housing inlet opening, and the second housing outlet opening may be disposed upstream from the first housing outlet opening.

In the fourth aspect of the present invention, a material of the housing may include metal. In the fourth aspect of the present invention, a material of the tubular mass exchanger may include one of a polymer and a resin. In the fourth aspect of the present invention, the housing may include a bypass conduit configured to direct the exhaust air stream away from the at least one housing inlet opening to prevent the exhaust air stream from entering the void.

In the fifth aspect of the present invention, the system may further comprise a bypass conduit configured to direct the exhaust air stream to bypass the humidification device to bypass humidifying the intake air stream using the water vapor separated from the exhaust air stream. The at least one valve may be fluidically coupled to the bypass conduit. The controller may be configured to command the at least one valve to open to direct the exhaust air stream to bypass the humidification device. In the fifth aspect of the present invention, the housing may define at least one opening configured to evacuate the exhaust air stream from the interior of the housing. In the fifth aspect of the present invention, the humidification device may be configured to receive the intake air stream from a heat exchanger coupled upstream from the humidification device.

In the fifth aspect of the present invention, the at least one of the plurality of valves may be a first valve. A second valve of the plurality of valves may be fluidically coupled to the housing to control removing the exhaust air stream from the interior of the housing. The controller may be configured to, in response to humidity of the intake air stream at the intake air inlet being less than a predefined threshold, command to open the second valve to remove the exhaust air stream. In the fifth aspect of the present invention, an amount of water vapor transferred by the tubular mass exchanger from the exhaust air stream to the intake air stream may be based on a difference between a first relative humidity of the exhaust air stream and a second relative humidity of the intake air stream. In the fifth aspect of the present invention, a third valve of the plurality of valves may be disposed upstream from the second valve and may be configured to remove the exhaust air stream from the interior of the housing.

The controller may be configured to operate the third valve to open in response to humidity of the intake air inlet being less than a second threshold. A first amount of water vapor extracted by the tubular mass exchanger from the exhaust air stream in response to opening the second valve may be less than a second amount of water vapor extracted by the tubular mass exchanger from the exhaust air stream in response to opening the third valve. In the fifth aspect of the present invention, the controller may be configured to command to close the first valve and the second valve in response to the humidity of the intake air stream at the intake air inlet being less than the second threshold.

In the fifth aspect of the present invention, a material of the housing may include metal. A material of the tubular mass exchanger may include one of a polymer and resin. In the fifth aspect of the present invention, the system may further comprise a sensor disposed within the intake air inlet and may be configured to detect humidity and temperature of the intake air stream directed into the intake air inlet. The controller may be communicatively coupled to receive signals from the sensor. The controller may command the at least one of the plurality of valves to open and to close based on the signals from the sensor.

The features illustrated or described in connection with one exemplary embodiment may be combined with any other feature or element of any other embodiment described herein. Such modifications and variations are intended to be included within the scope of the present disclosure. Further, a person skilled in the art will recognize that terms commonly known to those skilled in the art may be used interchangeably herein.

The above embodiments are described in sufficient detail to enable those skilled in the art to practice what is claimed and it is to be understood that logical, mechanical, and electrical changes may be made without departing from the spirit and scope of the claims. The detailed description is, therefore, not to be taken in a limiting sense.

As used herein, an element or step recited in the singular and proceeded with the word “a” or “an” should be understood as not excluding plural of said elements or steps, unless such exclusion is explicitly stated. Furthermore, references to “one embodiment” of the presently described subject matter are not intended to be interpreted as excluding the existence of additional embodiments that also incorporate the recited features. Specified numerical ranges of units, measurements, and/or values comprise, consist essentially or, or consist of all the numerical values, units, measurements, and/or ranges including or within those ranges and/or endpoints, whether those numerical values, units, measurements, and/or ranges are explicitly specified in the present disclosure or not.

Unless defined otherwise, technical and scientific terms used herein have the same meaning as is commonly understood by one of ordinary skill in the art to which this disclosure belongs. The terms “first,” “second,” “third” and the like, as used herein do not denote any order or importance, but rather are used to distinguish one element from another. The term “or” is meant to be inclusive and mean either or all of the listed items. In addition, the terms “connected” and “coupled” are not restricted to physical or mechanical connections or couplings, and can include electrical connections or couplings, whether direct or indirect.

Moreover, unless explicitly stated to the contrary, embodiments “comprising,” “including,” or “having” an element or a plurality of elements having a particular property may include additional such elements not having that property. The term “comprising” or “comprises” refers to a composition, compound, formulation, or method that is inclusive and does not exclude additional elements, components, and/or method steps. The term “comprising” also refers to a composition, compound, formulation, or method embodiment of the present disclosure that is inclusive and does not exclude additional elements, components, or method steps.

The phrase “consisting of” or “consists of” refers to a compound, composition, formulation, or method that excludes the presence of any additional elements, components, or method steps. The term “consisting of” also refers to a compound, composition, formulation, or method of the present disclosure that excludes the presence of any additional elements, components, or method steps.

The phrase “consisting essentially of” or “consists essentially of” refers to a composition, compound, formulation, or method that is inclusive of additional elements, components, or method steps that do not materially affect the characteristic(s) of the composition, compound, formulation, or method. The phrase “consisting essentially of” also refers to a composition, compound, formulation, or method of the present disclosure that is inclusive of additional elements, components, or method steps that do not materially affect the characteristic(s) of the composition, compound, formulation, or method steps.

Approximating language, as used herein throughout the specification and claims, may be applied to modify any quantitative representation that could permissibly vary without resulting in a change in the basic function to which it is related. Accordingly, a value modified by a term or terms, such as “about,” and “substantially” is not to be limited to the precise value specified. In some instances, the approximating language may correspond to the precision of an instrument for measuring the value. Here and throughout the specification and claims, range limitations may be combined and/or interchanged. Such ranges are identified and include all the sub-ranges contained therein unless context or language indicates otherwise.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable.

It is to be understood that the above description is intended to be illustrative, and not restrictive. For example, the above-described embodiments (and/or aspects thereof) may be used individually, together, or in combination with each other. In addition, many modifications may be made to adapt a particular situation or material to the teachings of the subject matter set forth herein without departing from its scope. While the dimensions and types of materials described herein are intended to define the parameters of the disclosed subject matter, they are by no means limiting and are exemplary embodiments. Many other embodiments will be apparent to those of skill in the art upon reviewing the above description. The scope of the subject matter described herein should, therefore, be determined with reference to the appended claims, along with the full scope of equivalents to which such claims are entitled.

This written description uses examples to disclose several embodiments of the subject matter set forth herein, including the best mode, and also to enable a person of ordinary skill in the art to practice the embodiments of disclosed subject matter, including making and using the devices or systems and performing the methods. The patentable scope of the subject matter described herein is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

While only certain features of the invention have been illustrated and described herein, many modifications and changes will occur to those skilled in the art. It is, therefore, to be understood that the appended claims are intended to cover all such modifications and changes as fall within the true spirit of the invention.

What is claimed is:

1. A humidification system comprising:
a heat exchanger fluidically coupled to a cathode outlet of a fuel cell stack to receive exhaust air stream therefrom and to cool the received exhaust air stream;
a water trapping device fluidically coupled to the heat exchanger and configured to trap water droplets extracted from the exhaust air stream by the heat exchanger to generate a dry exhaust air stream; and
an injector fluidically coupled to the water trapping device and configured to receive at least a portion of the water droplets trapped by the water trapping device, the injector fluidically coupled upstream from a cathode inlet of the fuel cell stack and configured to humidify a stream of air using the received portion of the water droplets prior to the stream of air entering the cathode inlet.

2. The system of claim 1, further comprising a turbine fluidically coupled to receive the dry exhaust air stream output by the water trapping device.

3. The system of claim 1, further comprising a fluid reservoir fluidically coupled between the water trapping device and the injector, wherein the fluid reservoir is configured to receive and store the water droplets from the water trapping device, and wherein the fluid reservoir is configured to selectively provide at least the portion of the water droplets to the injector.

4. The system of claim 3 further comprising a pump fluidically coupled between an outlet port of the fluid reservoir and a return port of the fluid reservoir, wherein the pump is configured to recirculate the water droplets output at the outlet port of the fluid reservoir toward the return port of the fluid reservoir.

5. The system of claim 4 further comprising a valve coupled between an outlet of the pump and the return port of the fluid reservoir, wherein the valve is configured to operate in a first position to permit flow of water output by the pump toward the return port and in a second position to prevent the flow of water toward the return port.

6. The system of claim 5 further comprising an injection branch fluidically coupled between the outlet of the pump and the valve, wherein the injector is coupled to the injection branch to receive at least the portion of the water droplets via the injection branch.

7. The system of claim 6, wherein the injector is configured to receive at least the portion of the water droplets by the injection branch in response to the valve being in the second position.

8. The system of claim 3 further comprising a filter fluidically coupled between the water trapping device and the fluid reservoir, wherein the filter is configured to filter the water droplets output by the water trapping device.

9. A method for humidifying a fuel cell of a fuel cell system comprising:
receiving exhaust air stream from a cathode outlet of a fuel cell stack and cooling the received exhaust air stream;
trapping water droplets extracted from the exhaust air stream to generate a dry exhaust air stream; and
receiving at least a portion of the water droplets and humidifying a stream of air using the received portion of the water droplets prior to the stream of air entering a cathode inlet of the fuel cell stack.

10. The method of claim 9 further comprising operating a turbine using the dry exhaust air stream.

11. The method of claim 10 further comprising, prior to receiving at least the portion of the water droplets and humidifying the stream of air, storing the water droplets.

12. The method of claim 11 further comprising recirculating the stored water droplets.

13. A humidification device comprising:
a tubular mass exchanger fluidically coupled to receive intake air stream and transfer intake air stream to an intake air inlet of a fuel cell stack; and
a housing configured to house the tubular mass exchanger to define a void therebetween, wherein the housing defines at least one housing inlet opening fluidically coupled to direct an exhaust air stream output by the fuel cell stack into the void, wherein the housing defines at least one housing outlet opening fluidically coupled to direct the exhaust air stream away from within the housing, and wherein the tubular mass exchanger is configured to extract water vapor from the exhaust air stream and transfer the extracted water vapor to the intake air stream flowing within the tubular mass exchanger to humidify the intake air stream to generate a humidified intake air stream.

14. The humidification device of claim 13, wherein an amount of water vapor extracted from the exhaust air stream and transferred to the intake air stream flowing within the tubular mass exchanger is based on a difference in a first relative humidity of the exhaust air stream and a second relative humidity of the intake air stream.

15. The humidification device of claim 13, wherein an amount of water vapor extracted from the exhaust air stream corresponds to a portion of a surface area of the tubular mass exchanger interacting with the exhaust air stream prior to exhaust air stream exiting the void.

16. The humidification device of claim 15, wherein the at least one housing outlet opening is a first housing outlet opening and the exhaust air stream interacts with a first portion of the surface area of the tubular mass exchanger prior to exiting the void through the first housing outlet opening, and wherein the housing defines a second housing outlet opening and the exhaust air stream interacts with a second portion of the surface area of the tubular mass exchanger prior to exiting the void through the second housing outlet opening.

17. The humidification device of claim 16, wherein the second portion is greater than the first portion.

18. The humidification device of claim 16, wherein the tubular mass exchanger extracts a first amount of water vapor from the exhaust air stream prior to the exhaust air stream exiting the void through the first housing outlet opening, wherein the tubular mass exchanger extracts a second amount of water vapor from the exhaust air stream prior to the exhaust air stream exiting the void through the second housing outlet opening, and wherein the second amount is greater than the first amount.

19. The humidification device of claim 16, wherein the at least one housing inlet opening is disposed immediately upstream from the intake air inlet of the fuel cell stack, wherein the first housing outlet opening is disposed upstream from the at least one housing inlet opening, and wherein the second housing outlet opening is disposed upstream from the first housing outlet opening.

20. The humidification device of claim 13, wherein the housing includes a bypass conduit configured to direct the exhaust air stream away from the at least one housing inlet opening to prevent the exhaust air stream from entering the void.
